(19) United States
(12) Patent Application Publication
(10) Pub. No.: US 2019/0384755 A1
(43) Pub. Date: Dec. 19, 2019

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Tomoyuki ITO, Kanagawa (JP); Shigehiro FURUKAWA, Kanagawa (JP); Masato ANDO, Kanagawa (JP)

(73) Assignee: FUJI XEROX CO., LTD., Tokyo (JP)

(21) Appl. No.: 16/436,196

(22) Filed: Jun. 10, 2019

(30) Foreign Application Priority Data
Jun. 18, 2018 (JP) 2018-115247
Jun. 18, 2018 (JP) 2018-115248

(51) Int. Cl. G06F 16/23

(52) U.S. Cl. CPC G06F 16/2358; G06F 16/2379

(57) ABSTRACT

An information processing apparatus includes: a first setting unit that sets how events in a relationship diagram change a second selling unit that sets, with respect to two of the events connected by a relationship line, whether a change in one of the two events is related to a change in another of the two events or there is no specifiable relationship between the changes; and a display unit that displays, according to the setting by the second setting unit, a relationship line in such a way that a relationship line indicating that a change in one event is related to a change in another event is distinguishable from a relationship line indicating that there is no specifiable relationship between a change in one event and a change in another event.

### CROSS-REFERENCE TO RELATED APPLICATIONS

This application is based on and claims priority under 35 USC 119 from Japanese Patent Application No. 2018-115247 filed Jun. 18, 2018 and Japanese Patent Application No. 2018-115248 filed Jun. 18, 2018.

### BACKGROUND

### (i) Technical Field

The present disclosure relates to an information processing apparatus and a non-transitory computer readable medium.

### (ii) Related Art

JP-A-2016-081185 discloses an object to facilitate creation of plural tables related to quality function deployment. The processing of the quality function deployment disclosed in JP-A-2016-081185 is performed as follows. Function items having a dependency relationship are connected according to the dependency relationship. On a system diagram in which plural function items are organized, a relationship diagram is created in which function items each belonging to any one process are each given attribute information that identifies the process to which the function item belongs. When the relationship diagram is input, each function item, attribute information of the function item, and dependency information of the function item are extracted from the relationship diagram, and stored as original information. Thereafter, axes for a deployment table or a multiple table are set, so that the original information is used to create and output a deployment table or a multiple table according to the set axes.

For example, in designing a product, a relationship diagram is used. Such a relationship diagram is suitable for describing results and their factors in detail without omission or redundancy. When a first event and a second event are related in such a relationship diagram, the first event and the second event are connected to each other by a relationship line. In this case, one event becomes a factor, and the other event becomes a result. In addition, there is usually a relationship in which as one event increases or decreases, the other event increases or decreases.

In some cases, however, it is not possible to specify a relationship between such changes although it is clear that there is a relationship between one event and the other event.

For example, in designing a product, a relationship diagram and a deployment table are used, and in particular, conversion from the relationship diagram into the deployment table is performed in some cases. When the relationship diagram is created, it is desirable that the relationship diagram is freely created without restrictions on ideas and finally causal relationships are drawn without inconsistency. Meanwhile, when the relationship diagram is freely drawn, a causal relationship not expressible in the deployment table may occur. When the causal relationship is incorrect, correction is necessary. Meanwhile, in some cases, such an error is not recognizable, which makes correction impossible.

### SUMMARY

Aspects of non-limiting embodiments of the present disclosure relate to providing an information processing apparatus and a non-transitory computer readable medium, which make it possible for a relationship line indicating a relationship between events to facilitate the user to understand that a change in one event is related to a change in another event or that there is no specifiable relationship between such changes, when a relationship diagram is displayed.

Aspects of non-limiting embodiments of the present disclosure also relate to providing an information processing apparatus and a non-transitory computer readable medium, which make it possible for the user to know that there is a causal relationship not expressible in a deployment table among causal relationships between events in a relationship diagram.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including: a first setting unit that sets how events in a relationship diagram change; a second setting unit that sets, with respect to two of the events connected by a relationship line, whether a change in one of the two events is related to a change in another of the two events or there is no specifiable relationship between the changes; and a display unit that displays, according to the setting by the second setting unit, a relationship line in such a way that a relationship line indicating that a change in one event is related to a change in another event is distinguishable from a relationship line indicating that there is no specifiable relationship between a change in one event and a change in another event.

### BRIEF DESCRIPTION OF THE DRAWINGS

Exemplary embodiments of the present disclosure will be described in detail based on the following figures, wherein:

FIG. 1 is a schematic module diagram of an example of a configuration according to a first exemplary embodiment;

FIG. 2 is an explanatory view illustrating an example of a system configuration according to the exemplary embodiment;

FIG. 3 is a flowchart illustrating an example of a processing according to the first exemplary embodiment;

FIG. 4 is an explanatory view of an example of a technique as a target of a relationship diagram and a deployment table;

FIG. 5 is an explanatory view illustrating an example of the relationship diagram;

FIG. 6 is an explanatory view illustrating an example of the relationship diagram;

FIG. 7 is an explanatory view illustrating an example of the relationship diagram;

FIG. 8 is an explanatory view illustrating an example of the deployment table;

FIG. 9 is an explanatory view illustrating an example of a data structure of a relationship diagram information table;

FIG. 10 is an explanatory view illustrating an example of a data structure of an item information table;

FIG. 11 is an explanatory view illustrating an example of a data structure of a relationship line information table;

FIG. 12 is an explanatory view illustrating an example of a data structure of a deployment table information table;

FIG. 13 is an explanatory view illustrating an example of a data structure of an axis item information table;

FIG. 14 is an explanatory view illustrating an example of a data structure of a causal relationship information table;

FIG. 15 is an explanatory view illustrating an example of a data structure of a relationship diagram ID deployment table ID relationship table;

FIG. 16 is an explanatory view illustrating an example of a data structure of an item ID axis item ID relationship table;

FIG. 17 is an explanatory view illustrating an example of a data structure of a relationship line ID causal relationship information ID relationship table;

FIG. 18 is a flowchart illustrating an example of a processing according to the first exemplary embodiment;

FIGS. 19A and 19B are explanatory views illustrating an example of a processing according to the first exemplary embodiment;

FIG. 20 is an explanatory view illustrating an example of a processing according to the first exemplary embodiment;

FIGS. 21A and 21B are explanatory views illustrating an example of a processing according to the first exemplary embodiment;

FIGS. 22A and 22B are explanatory views illustrating an example of a processing according to the first exemplary embodiment;

FIGS. 23A and 23B are explanatory views illustrating an example of a processing according to the first exemplary embodiment;

FIGS. 24A and 24B are explanatory views illustrating an example of a processing according to the first exemplary embodiment;

FIGS. 25A and 25B are explanatory views illustrating an example of a processing according to the first exemplary embodiment;

FIGS. 26A and 26B are explanatory views illustrating an example of a processing according to the first exemplary embodiment;

FIGS. 27A and 27B are explanatory views illustrating an example of a processing according to the first exemplary embodiment;

FIG. 28 is a schematic module diagram of an example of a configuration according to a second exemplary embodiment;

FIG. 29 is a flowchart illustrating an example of a processing according to the second exemplary embodiment;

FIG. 30 is a flow chart illustrating an example of a processing according to the second exemplary embodiment;

FIG. 31 is an explanatory view illustrating an example of a data structure of a relationship diagram term deployment table term correspondence table;

FIG. 32 is an explanatory view illustrating an example of a data structure of the relationship diagram term deployment table term correspondence table;

FIG. 33 is an explanatory view illustrating an example of a relationship diagram;

FIG. 34 is an explanatory view illustrating an example of the relationship diagram;

FIG. 35 is an explanatory view illustrating an example of a deployment table;

FIG. 36 is a schematic module diagram of an example of a configuration according to a third exemplary embodiment;

FIG. 37 is a flowchart illustrating an example of a processing according to the third exemplary embodiment;

FIG. 38 is a flowchart illustrating an example of a processing according to the third exemplary embodiment;

FIG. 39 is an explanatory view illustrating an example of a relationship diagram;

FIG. 40 is an explanatory view illustrating an example of a deployment table;

FIG. 41 is an explanatory view illustrating an example of a data structure of a relationship diagram term deployment table term correspondence table;

FIG. 42 is an explanatory view illustrating an example of a data structure of the relationship diagram term deployment table term correspondence table; and

FIG. 43 is a block diagram illustrating an example of a hardware configuration of a computer that implements the exemplary embodiment.

### DETAILED DESCRIPTION

Hereinafter, descriptions will be made on examples of various exemplary embodiments suitable for implementing the disclosure with reference to the accompanying drawings.

### First Exemplary Embodiment

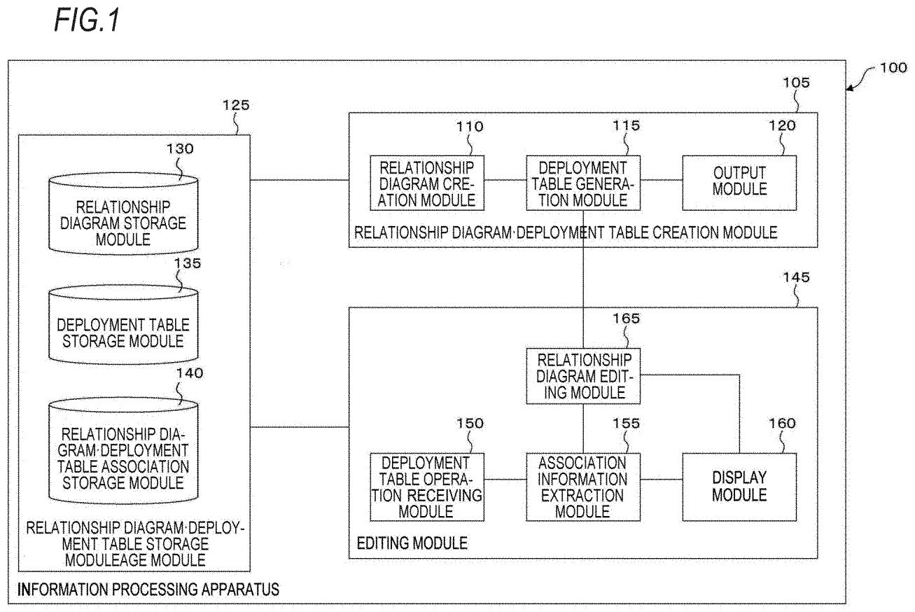

FIG. 1 illustrates a schematic module diagram of an example of a configuration in a first exemplary embodiment.

A module generally refers to a logically separable component such as software (a computer program) or hardware. Accordingly, a module in the present exemplary embodiment refers to not only a module in a computer program, but also a module in a hardware configuration. Thus, the present exemplary embodiment also describes a computer program (a program causing a computer to execute each procedure, a program causing a computer to function as each unit, and a program causing a computer to implement each function), a system and a method, which are allowed to serve as these modules. Meanwhile, for the convenience of descriptions, the expressions “store” “caused to be stored,” and equivalent expressions ill be used. When the exemplary embodiment relates to a computer program, the expressions indicate that the computer program is stored or controlled to be stored in a storage device. In addition, one module may correspond to one function. In implementation, however, one module may be constituted by one program, plural modules may be constituted by one program, and conversely, one module may be constituted by plural programs. Further, plural modules may be executed by one computer, or one module may be executed by plural computers in a distributed or parallel environment. In addition, one module may include another module. In addition, hereinafter, the term “connection” is used for a case of not only a physical connection, but also a logical connection (e.g., a data exchange, an instruction, a reference relationship between data, and a login). The term “predetermined” refers to being determined prior to a target processing, and includes the meaning of being determined according to a circumstance/state at or until a specific time point as long as the target processing is not yet performed before a processing according to the present exemplary embodiment is started, or even after the processing according to the present exemplary embodiment is started. When plural “predetermined values” exist, the values may be different from each other, or two or more of the values (including any values) may be identical to each other. In addition, the description “when it is A, B is performed” indicates that “it is determined whether it is A or not, and when it is determined that it is A, B is performed,” except for a case where the determination of whether it is A or not is unnecessary. In addition, when items are enumerated like “A, B, and C,” the enumeration is merely exemplary unless otherwise specified, and includes a case where only one (e.g., only A) is selected.

In addition, a configuration of a system or an apparatus includes not only a configuration in which, for example, plural computers, hardware components, and apparatuses are connected to each other via a communication unit such as a network (including a one-to-one corresponding communication connection), but also a configuration implemented with, for example, one computer, hardware component, or apparatus. The terms “apparatus” and “system” are used to have the same meaning. The “system” does not include a system that is merely a social “structure” (social system) which is an artificial engagement.

In each processing by each module or in each of plural processes in a case where the plural processes are performed in the module, target information is read from a storage device, and a processing result is written in the storage device after the processing is performed. Accordingly, descriptions regarding the reading from the storage device prior the processing, and the writing in the storage device after the processing may be omitted. In addition, examples of the storage device may include a hard disk, a random access memory (RAM), an external storage medium, a storage device via a communication line, and a register in a central processing unit (CPU).

An information processing apparatus 100 according to the first exemplary embodiment edits a relationship diagram and a deployment table, and includes a relationship diagram deployment table creation module 105, a relationship diagram deployment table storage module 125, and an editing module 145 as illustrated in the example of FIG. 1.

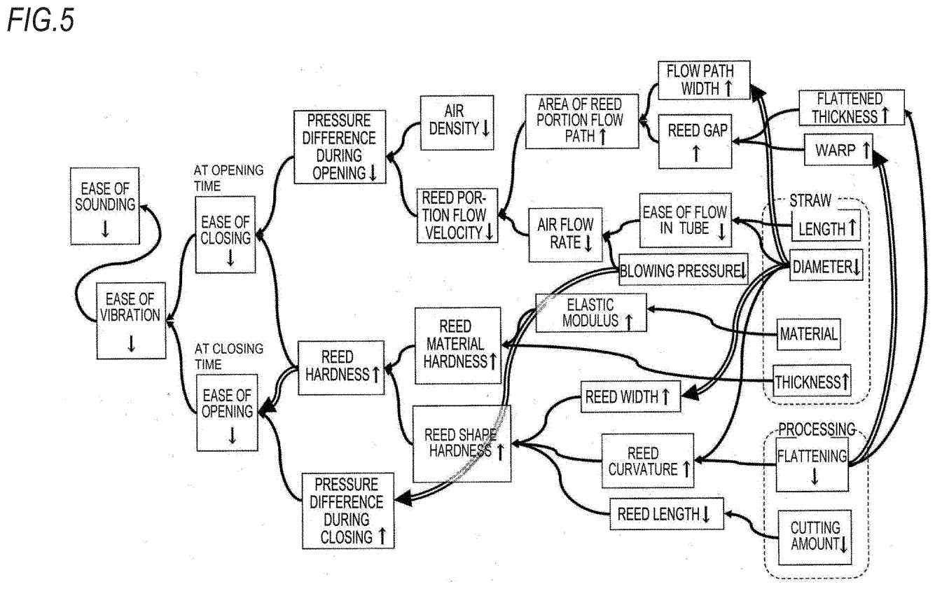

Here, the use of the “relationship diagram” is a method used to clarify a causal relationship in a circumstance where a problem sought to be solved is clear, and causes of the occurrence of the problem are intertwined with each other. The relationship diagram is made up of items and relationship lines as illustrated in the example of FIG. 5. Here, the “item” corresponds to a node (node, vertex) in a graph theory. The “relationship line” corresponds to an edge (branch) in the graph theory. That is, the “relationship diagram” expresses relationships through connections between the items (also called events) via the relationship lines (also called connection lines). For example, a tree diagram (also called, for example, a tree graph) is a typical example.

The “deployment table (also called a quality function deployment table)” indicates relationships between items listed on plural axes orthogonal to each other, through symbols or numerical values arranged in a matrix form.

The relationship diagram deployment table creation module 105 includes a relationship diagram creation module 110, a deployment table generation module 115, and an output module 120, and is connected to the relationship diagram deployment table storage module 125. The relationship diagram deployment table creation module 105 creates a relationship diagram, generates a deployment table from the relationship diagram, and outputs the relationship diagram and the deployment table. For example, the technique described in JP-A-2016-081185 may be used.

The relationship diagram creation module 110 is connected to the deployment table generation module 115. The relationship diagram creation module 110 receives information required for creating a relationship diagram. For example, the relationship diagram creation module 110 receives information, such as a name of a relationship diagram, items, item contents (attribute information of the items), and relationship lines (a dependency relationship between the items (dependency information, attribute information of the relationship lines)), which is created through, for example, an operation of keyboard keys and a mouse by a user on a user interface displayed on a display device such as a liquid crystal display. In addition to receiving the information through, for example, the operation of keyboard keys by the user, information stored in, for example, a hard disk (including one connected via, for example, a network, in addition to one mounted in a computer) may be read.

For example, the relationship diagram creation module 110 receives plural elements, attribute information of each element, which includes a process to which the element belongs, and a causal relationship between the plural elements to create or edit a relationship diagram.

The deployment table generation module 115 is connected to the relationship diagram creation module 110, the output module 120, and a relationship diagram editing module 165 of the editing module 145. The deployment table generation module 115 generates a deployment table with respect to a relationship diagram created by the relationship diagram creation module 110.

When a relationship diagram displayed by a display module 160 is corrected, the deployment table generation module 115 may generate a deployment table from the corrected relationship diagram. That is, the deployment table generation module 115 may generate a deployment table with respect to not only a relationship diagram created by the relationship diagram creation module 110, but also a relationship diagram edited by the relationship diagram editing module 165. In this generation processing, a relationship diagram ID deployment table ID relationship table 1500, an item ID axis item ID relationship table 1600, and a relationship line ID causal relationship information ID relationship table 1700 in a relationship diagram deployment table association storage module 140 are generated.

The output module 120 is connected to the deployment table generation module 115. The output module 120 outputs a relationship diagram created by the relationship diagram creation module 110 (that may include a relationship diagram edited by the relationship diagram editing module 165), and a deployment table generated by the deployment table generation module 115 (that may include a deployment table generated based on the relationship diagram created by the relationship diagram creation module 110, and a deployment table generated based on the relationship diagram edited by the relationship diagram editing module 165). Here, examples of outputting the relationship diagram and the deployment table may include displaying on a display device such as a display, printing with a printing device such as a printer, transmitting an image through an image transmission device such as a facsimile, writing on a storage device such as a database, storing in a storage medium such as a memory card, and transferring to another information processing apparatus.

The relationship diagram deployment table storage module 125 includes a relationship diagram storage module 130, a deployment table storage module 135, and the relationship diagram deployment table association storage module 140, and is connected to the relationship diagram deployment table creation module 105, and the editing module 145. The relationship diagram deployment table storage module 125 stores information on a relationship diagram and a deployment table.

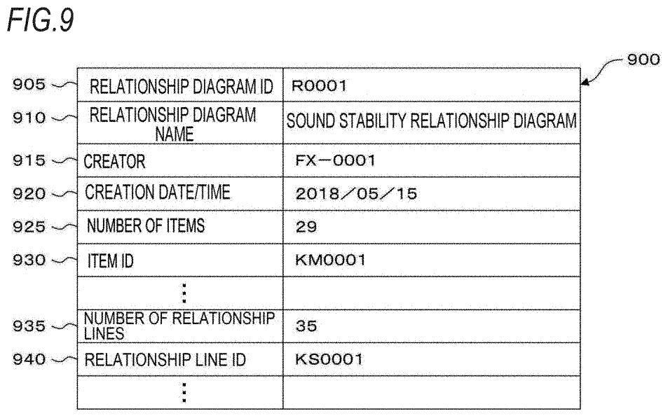

The relationship diagram storage module 130 stores information of a relationship diagram. As a specific example, the relationship diagram storage module 130 stores a relationship diagram information table 900, an item information table 1000, and a relationship line information table 1100. FIG. 9 is an explanatory view illustrating an example of a data structure of the relationship diagram information table 900. The relationship diagram information table 900 includes a relationship diagram ID field 905, a relationship diagram name field 910, a creator field 915, a creation date/time field 920, a number of items field 925, an item ID field 930, a number of relationship lines field 935, and a relationship line ID field 940. The relationship diagram ID field 905 stores information for uniquely identifying a relationship diagram (relationship diagram identification (ID), in the first exemplary embodiment. The relationship diagram name field 910 stores a name of the relationship diagram of the relationship diagram ID. The creator field 915 stores a creator of the relationship diagram. The creation date/time field 920 stores date/time when the relationship diagram is created or edited (year, month, day, hour, minute, second, sub-second, or a combination thereof). The number of items field 925 stores the number of items in the relationship diagram. The item ID field 930 is subsequently continued in accordance with the number of items in the number of items field 925. The item ID field 930 stores information for uniquely identifying an item (item ID), in the first exemplary embodiment. The information indicated by the item ID is stored in the item information table 1000. The number of relationship lines field 935 stores the number of relationship lines in the relationship diagram. The relationship line ID field 940 is subsequently continued in accordance with the number of relationship lines in the number of relationship lines field 935. The relationship line ID field 940 stores information for uniquely identifying a relationship line (relationship line ID), in the first exemplary embodiment. The information indicated by the relationship line ID is stored in the relationship line information table 1100.

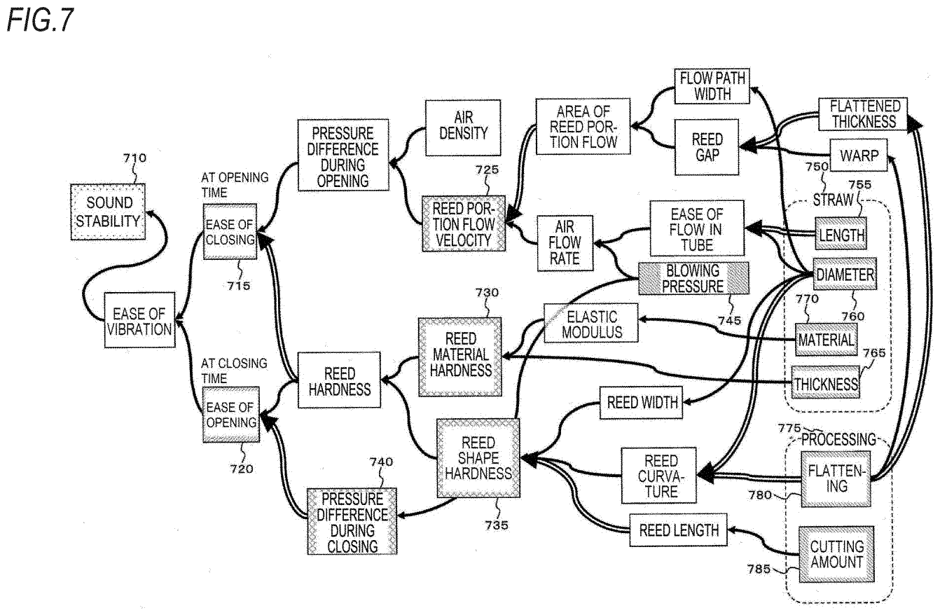

For example, regarding the “sound stability relationship diagram” illustrated in FIG. 7, as illustrated in FIG. 9, the relationship diagram information table 900 stores “R0001” in the relationship diagram ID field 905, “sound stability relationship diagram” in the relationship diagram name field 910, “FX-0001” in the creator field 915, “2018 May 15” in the creation date/time field 920, “29” in the number of items field 925, “KM0001” in the item ID field 930, “35” in the number of relationship lines field 935, and “KS0001” in the relationship line ID field 940, respectively.

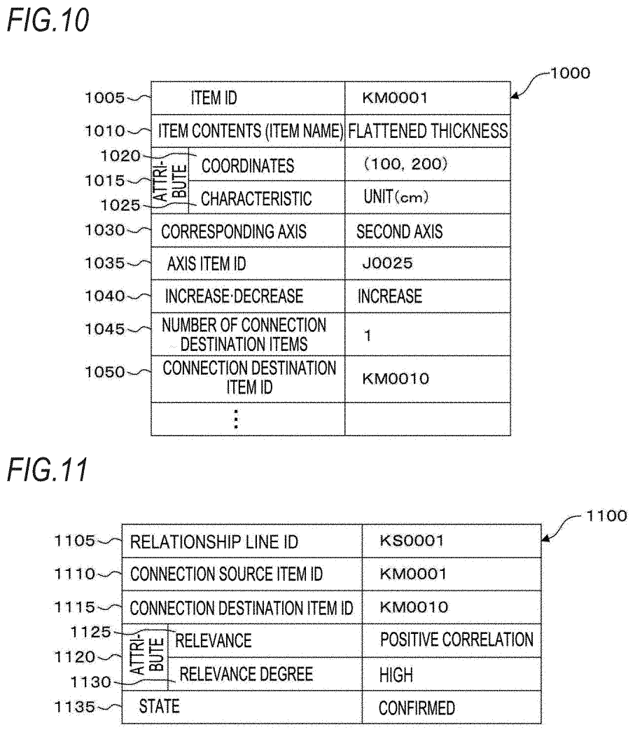

FIG. 10 is an explanatory view illustrating an example of a data structure of the item information table 1000. The item information table 1000 includes an item ID field 1005, an item contents field 1010, an attribute field 1015, a corresponding axis field 1030, an axis item ID field 1035, an increase decrease field 1040, a number of connection destination items field 1045, and a connection destination item ID field 1050. Here, the attribute field 1015 includes a coordinate field 1020, and a characteristic field 1025. The item ID field 1005 stores an item ID for identifying an item. The item contents field 1010 stores item contents of the item ID (e.g., an item name). The attribute field 1015 stores various attributes. The coordinate field 1020 stores coordinates indicating a position of a display on a relationship diagram. These coordinates may be coordinates indicating an absolute position with the origin at the upper left, or may be coordinates indicating a relative position. The characteristic field 1025 stores the characteristic of contents expressed by this item. The corresponding axis field 1030 stores a corresponding axis on a deployment table. The axis item ID field 1035 stores an axis item ID for identifying each of items defined on plural axes expressed on the deployment table. The increase decrease field 1040 stores information as to whether a value expressing a characteristic is increasing or decreasing. The number of connection destination items field 1045 stores the number of items as destinations to which the item is connected. The connection destination item ID field 1050 is subsequently continued in accordance with the number of items in the number of connection destination items field 1045. The connection destination item ID field 1050 stores a connection destination item ID.

For example, regarding the “sound stability relationship diagram” illustrated in FIG. 7, as illustrated in FIG. 10, the item information table 1000 stores “KM0001” in the item ID field 1005, “flattened thickness” in the item contents (item name) field 1010. “(100, 200)” in the coordinate field 1020 of the attribute field 1015, “unit (cm)” in the characteristic field 1025 of the attribute field 1015, “second axis” in the corresponding axis field 1030, “J0025” in the axis item ID field 1035, “increase (positive)” in the increase decrease field 1040, “1” in the number of connection destination items field 1045, and “KM0010” in the connection destination item ID field 1050, respectively. In addition, for example, “parametervalue” and “target value” may be included in the coordinate field 1020 of the attribute field 1015. In addition, for example, “decrease negative)” and “unknown” may be included in the increase decrease field 1040.

FIG. 11 is an explanatory view illustrating an example of a data structure of the relationship line information table 1100. The relationship line information table 1100 includes a relationship line ID field 1105, a connection source item ID field 1110, a connection destination item ID field 1115, an attribute field 1120, and a state field 1135. The attribute field 1120 includes a relevance field 1125, and a relevance degree field 1130. The relationship line ID field 1105 stores a relationship line ID. The connection source item ID field 1110 stores an item ID of an item as a connection source on the relationship line. The connection destination item ID field 1115 stores an item ID of an item as a connection destination on the relationship line. The attribute field 1120 stores attributes of the relationship line. As the attributes, for example, there is a relationship between items connected by the relationship line (e.g., a relationship in which as a numerical value of an item as a connection source increases, a numerical value of an item as a connection destination increases (e.g., direct proportion), or a relationship in which as a numerical value of an item as a connection source increases, a numerical value of an item as a connection destination decreases (e.g., inverse proportion)). The relevance field 1125 stores a relevance. The relevance degree field 1130 stores a relevance degree.

For example, regarding the “sound stability relationship diagram” illustrated in FIG. 7, as illustrated in FIG. 11, the relationship line information table 1100 stores “KS0001” in the relationship line ID field 1105, “KM0001” in the connection source item ID field 1110, “KM0010” in the connection destination item ID field 1115, “positive correlation” in the relevance field 1125 of the attribute field 1120, “high” in the relevance degree field 1130 of the attribute field 1120, and “confirmed” in the state field 1135, respectively. In addition, there may be, for example, “inverse correlation” or “unknown” in the relevance field 1125 of the attribute field 1120, in addition, there may be, for example, “medium,” “small,” or “unknown” in the relevance degree field 1130 of the attribute field 1120. In addition, there may be, for example, “unconfirmed” or “rejected” in the state field 1135.

FIGS. 9 to 11 are merely exemplary, and other data structures may be employed. For example, a data structure indicating a graph structure may be used.

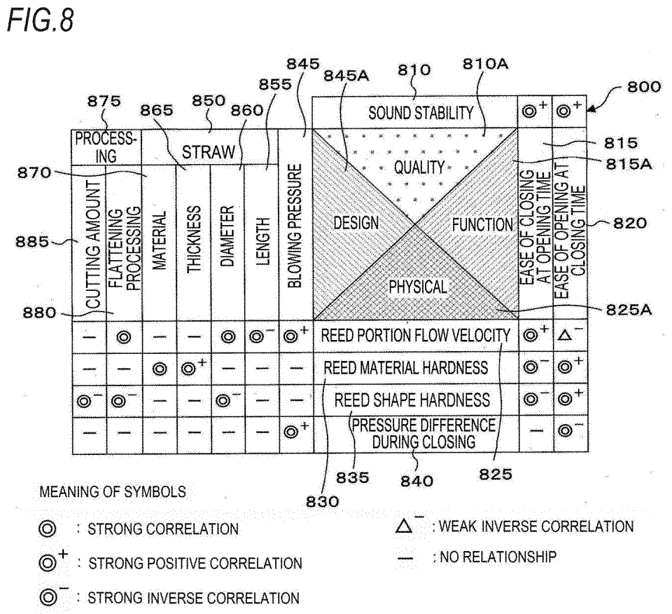

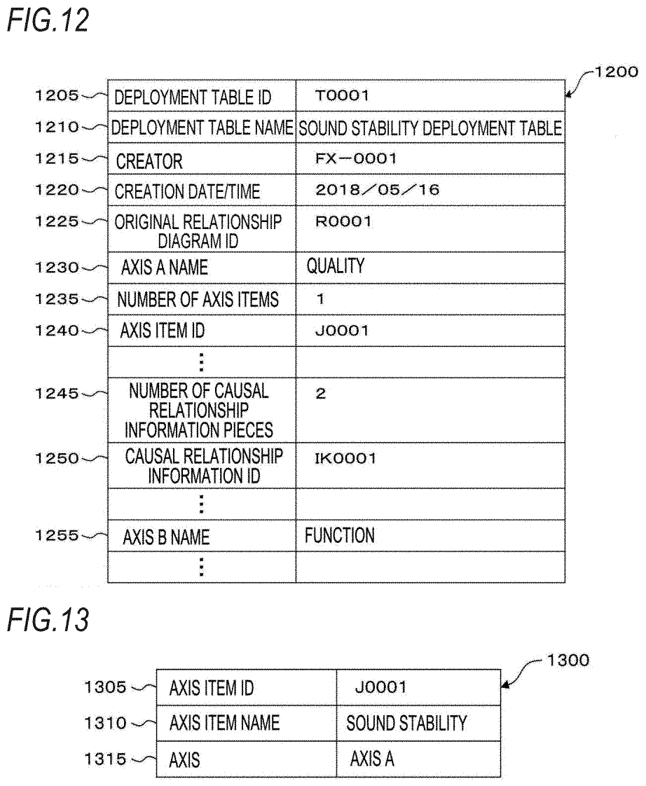

The deployment table storage module 135 stores information of a deployment table. As a specific example, the deployment table storage module 135 stores a deployment table information table 1200, an axis item information table 1300, and a causal relationship information table 1400. FIG. 12 is an explanatory view illustrating an example of a data structure of the deployment table information table 1200. The deployment table information table 1200 includes, for example, a deployment table ID field 1205, a deployment table name field 1210, a creator field 1215, a creation date/time field 1220, an original relationship diagram ID field 1225, an axis A name field 1230, a number of axis items field 1235, an axis item ID field 1240, a number of causal relationship information pieces field 1245, and a causal relationship information ID field 1250. The deployment table ID field 1205 stores information for uniquely identifying a deployment table (deployment table ID), in the first exemplary embodiment. The deployment table name field 1210 stores a name of the deployment table with the deployment table ID. The creator field 1215 stores a creator of the deployment table. The creation date/time field 1220 stores the date/time when the deployment table is created. The original relationship diagram ID field 1225 stores a relationship diagram ID as a source from which the deployment table is made. That is, the deployment table generation module 115 refers to the corresponding relationship diagram when generating the deployment table. The axis A name field 1230 stores a name of an axis A (first axis). For example, this corresponds to a name (quality) of a first axis (quality) 810A illustrated in FIG. 8. Regarding the axis A, there are the number of axis items field 1235 to the causal relationship information ID field 1250. Then, in a case of four axes, the same data as the number of axis items field 1235 to the causal relationship information ID field 1250 is present for an axis B, an axis C, and an axis D as well. The number of axis items field 1235 stores the number of items in the axis (axis A). The axis item ID field 1240 is subsequently continued as many times as the number of items in the number of axis items field 1235. The axis item ID field 1240 stores information (axis item ID) that uniquely identifies an axis item in the first exemplary embodiment. The information indicated by the axis item ID is stored in the axis item information table 1300. The number of causal relationship information pieces field 1245 stores the number of causal relationship information pieces. The causal relationship information indicates a field (cell) in which, for example, “⊚,” “Δ,” or “□” is described in the example of FIG. 8. The causal relationship information ID field 1250 is subsequently continued in accordance with the number of causal relationship information pieces in the number of causal relationship information pieces field 1245. The causal relationship information ID field 1250 stores information for uniquely identifying causal relationship information (causal relationship information ID), in the first exemplary embodiment. Similar fields are repeatedly continued for an axis B, an axis C, and an axis D (second axis to fourth axis) (such as the axis B name field 1255 storing a name of an axis B) as well. The information indicated by the causal relationship information ID is stored in the causal relationship information table 1400.

For example, regarding a “sound stability deployment table” illustrated in FIG. 8, as illustrated in FIG. 12, the deployment table information table 1200 stores “T0001” in the deployment table ID field 1205, “sound stability deployment table” in the deployment table name field 1210, “FX-0001” in the creator field 1215, “2018 May 16” in the creation date/time field 1220, “R0001” in the original relationship diagram ID field 1225, “quality” in the axis A name field 1230, “1” in the number of axis items field 1235, “J0001” in the axis item ID field 1240, “2” in the number of causal relationship information pieces field 1245, and “IK0001” in the causal relationship information ID field 1250, respectively.

FIG. 13 is an explanatory view illustrating an example of a data structure of the axis item information table 1300. The axis item information table 1300 includes an axis item ID field 1305, an axis item name field 1310, and an axis field 1315. The axis item ID field 1305 stores an axis item ID. The axis item name field 1310 stores a name of an axis item with the axis item ID. For example, this corresponds to a name (sound stability) of an axis item (sound stability) 810 illustrated in FIG. 8. The axis field 1315 stores an axis to which the axis item belongs.

For example, regarding the “sound stability deployment table” illustrated in FIG. 8, as illustrated in FIG. 13, the axis item information table 1300 stores “J0001” in the axis item ID field 1305, “sound stability” in the axis item name field 1310, and “axis A” in the axis field 1315, respectively.

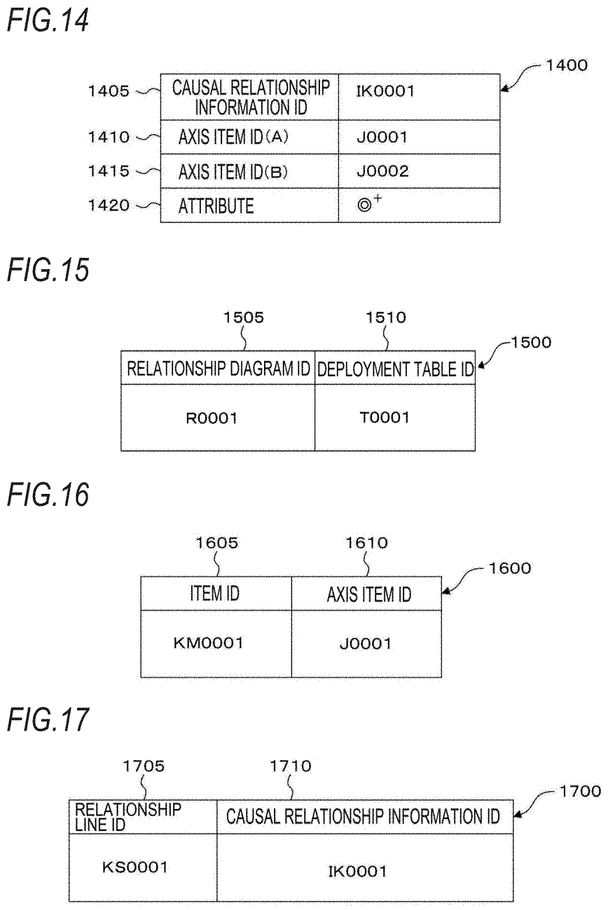

FIG. 14 is an explanatory view illustrating an example of a data structure of the causal relationship information table 1400. The causal relationship information table 1400 includes a causal relationship information ID field 1405, an axis item ID (A) field 1410, an axis item ID (B) field 1415, and an attribute field 1420. The causal relationship information ID field 1405 stores a causal relationship information ID. The axis item ID (A) field 1410 stores an axis item ID (A). The axis item ID (B) field 1415 stores an axis item ID (B). That is, a position where the axis item ID (A) field 1410 and the axis item ID (B) field 1415 cross each other indicates a position of the causal relationship information on a deployment table. The attribute field 1420 stores attributes. For example, information such as “⊚+,” “⊚−,” “Δ+,” “Δ−,” and “□” corresponds to the attributes.

For example, regarding the “sound stability deployment table” illustrated in FIG. 8, as illustrated in FIG. 14, the causal relationship information table 1400 stores “IK0001” in the causal relationship information ID field 1405, “J0001” in the axis item ID (A) field 1410, “J0002” in the axis item If) (B) field 1415, and “⊚+” in the attribute field 1420, respectively.

The relationship diagram deployment table association storage module 140 associates a deployment table with a relationship diagram. The relationship diagram deployment table association storage module 140 stores, for example, information that associates a deployment table with a relationship diagram. As a specific example. FIG. 15 is an explanatory view illustrating an example of a data structure of the relationship diagram ID deployment table ID relationship table 1500. The relationship diagram ID deployment table ID relationship table 1500 includes a relationship diagram ID field 1505, and a deployment table ID field 1510. The relationship diagram ID field 1505 stores a relationship diagram ID. The deployment table ID field 1510 stores a deployment table ID corresponding to the relationship diagram ID. Specifically, when the deployment table generation module 115 generates a deployment table from a relationship diagram, the relationship diagram ID deployment table ID relationship table 1500 is generated. The value of the relationship diagram ID field 1505 is a relationship diagram ID indicating the relationship diagram as a generation source, and the value of the deployment table ID field 1510 is a deployment table ID indicating the generated deployment table. Plural deployment tables may correspond to one relationship diagram. This is because it is possible to generate plural deployment tables depending on which item in a relationship diagram is selected as an axis item of a deployment table.

For example, regarding the correspondence between the “sound stability relationship diagram” illustrated in FIG. 7 and the “sound stability deployment table” illustrated in FIG. 8, as illustrated in FIG. 15, the relationship diagram ID deployment table ID relationship table 1500 stores “R0001” in the relationship diagram ID field 1505, and “T0001” in the deployment table ID field 1510, respectively.

Then, the relationship diagram deployment table association storage module 140 associates an axis item, that is an item included in an axis of a deployment table, with an item in a relationship diagram. The relationship diagram deployment table association storage module 140 stores, for example, information that associates an axis item, that is an item included in an axis of a deployment table, with an item in a relationship diagram. As a specific example, FIG. 16 is an explanatory view illustrating an example of a data structure of the item ID axis item ID relationship table 1600. The item ID axis item ID relationship table 1600 includes an item ID field 1605, and an axis item ID field 1610. The item ID field 1605 stores an item ID. The axis item ID field 1610 stores an axis item ID. Specifically, when the deployment table generation module 115 generates a deployment table from a relationship diagram, the item ID axis item ID relationship table 1600 is generated. The value of the item ID field 1605 is an item ID indicating an item of the relationship diagram as a generation source, and the value of the axis item ID field 1610 is an axis item ID indicating an axis item of the generated deployment table.

For example, regarding the correspondence between the “sound stability relationship diagram” illustrated in FIG. 7 and the “sound stability deployment table” illustrated in FIG. 8, as illustrated in FIG. 16, the item ID axis item ID relationship table 1600 stores “KM0001” in the item ID field 1605, and “J0001” in the axis item ID field 1610, respectively.

Then, the relationship diagram deployment table association storage module 140 associates causal relationship information that indicates a causal relationship between two axis items on adjacent axes in a deployment table, with a relationship line connecting items to each other on a relationship diagram. Here, “two axis items on adjacent axes” refers to axis items A1 and B1 on axes A and B adjacent to each other. The relationship diagram deployment table association storage module 140 stores, for example, information that associates causal relationship information that indicates a causal relationship between two axis items on adjacent axes in a deployment table, with a relationship line connecting items to each other on a relationship diagram. As a specific example, FIG. 17 is an explanatory view illustrating an example of a data structure of the relationship line ID causal relationship information ID relationship table 1700. The relationship line ID causal relationship information ID relationship table 1700 includes a relationship line ID field 1705, and a causal relationship information ID field 1710. The relationship line ID field 1705 stores a relationship line ID. The causal relationship information ID field 1710 stores a causal relationship information ID. Specifically, when the deployment table generation module 115 generates a deployment table from a relationship diagram, the relationship line ID causal relationship information ID relationship table 1700 is generated. The value of the relationship line ID field 1705 is a relationship line ID indicating a relationship line on the relationship diagram as a generation source, and the value of the causal relationship information ID field 1710 is a causal relationship information ID indicating causal relationship information of the generated deployment table. Plural relationship line IDs may correspond to one causal relationship information ID. This is because depending on selection of items as axis items, one or more items (items not selected as the axis items) may be sandwiched between the items. Specifically, this is because in a case where an item A and an item C are selected as axis items, but an item B is present between the item A and the item C (more specifically, in a case where there is no relationship line directly connected from the item A to the item C, and there are a relationship line connecting the item A to the item B, and a relationship line connecting the item B to the item C), one causal relationship information piece present between the axis item A and the axis item C on a deployment table may correspond to two relationship lines (the relationship line connecting the item A to the item B, and the relationship line connecting the item B to the item C) on a corresponding relationship diagram.

For example, regarding the correspondence between the “sound stability relationship diagram” illustrated in FIG. 7 and the “sound stability deployment table” illustrated in FIG. 8, as illustrated in FIG. 17, the relationship line ID causal relationship information ID relationship table 1700 stores “KS0001” in the relationship line ID field 1705, and “IK0001” in the causal relationship information ID field 1710, respectively.

The editing module 145 includes a deployment table operation receiving module 150, an association information extraction module 155, the display module 160, and the relationship diagram editing module 165, and is connected to the relationship diagram deployment table storage module 125. The editing module 145 performs, for example, editing of a deployment table and editing of a relationship diagram generated by the editing of the deployment table. For example, when an editing request is issued with respect to a deployment table generated by the deployment table generation module 115, a relationship diagram corresponding to the deployment table is extracted, and a demand for editing is made. Based on the editing result, the deployment table generation module 115 is instructed to generate a deployment table again. Accordingly, the editing result may be reflected in the deployment table, and thus the identity of information may be maintained between the relationship diagram and the deployment table.

The deployment table operation receiving module 150 is connected to the association information extraction module 155. The deployment table operation receiving module 150 receives editing information on a deployment table through, for example, an operation of keyboard keys and a mouse by a user. In addition to receiving the editing information through, for example, the operation of keyboard keys by the user, previously created editing information stored in, for example, a hard disk may be read. For example, a correction operation of integrating plural axis items present on one axis in a deployment table may be performed.

The association information extraction module 155 is connected to the deployment table operation receiving module 150, the display module 160, and the relationship diagram editing module 165. The association information extraction module 155 extracts a relationship diagram from a deployment table, extracts an item of the relationship diagram from an axis item of the deployment table, and extracts a relationship line of the relationship diagram from causal relationship information of the deployment table by using the relationship diagram ID deployment table ID relationship table 1500, the item ID axis item ID relationship table 1600, and the relationship line ID causal relationship information ID relationship table 1700 in the relationship diagram deployment table association storage module 140. That is, in the deployment table operation receiving module 150, a relationship diagram, an item of the relationship diagram, and a relationship line of the relationship diagram are extracted from a deployment table as an editing target, an axis item of the deployment table, and causal relationship information of the deployment table, respectively.

The display module 160 is connected to the association information extraction module 155 and the relationship diagram editing module 165. The display module 160 displays a relationship diagram associated with a deployment table to be corrected, by using one or more of the relationship diagram ID deployment table ID relationship table 1500, the item ID axis item ID relationship table 1600, and the relationship line ID causal relationship information ID relationship table 1700. For example, the relationship diagram ID deployment table ID relationship table 1500 is used to extract a relationship diagram from a deployment table, the relationship diagram ID deployment table ID relationship table 1500 and the item ID axis item ID relationship table 1600 are used to extract an item of the relationship diagram from an axis item of the deployment table, the relationship diagram ID deployment table ID relationship table 1500 and the relationship line ID causal relationship information ID relationship table 1700 are used to extract a relationship line of the relationship diagram from causal relationship information of the deployment table, the relationship diagram ID deployment table ID relationship table 1500, the item ID axis item ID relationship table 1600, and the relationship line ID causal relationship information ID relationship table 1700 are used to extract an item and a relationship line of the relationship diagram from an axis item, and causal relationship information of the deployment table, respectively. Here, “to be corrected” may correspond to a state as a result of correction, or a state as a correction target for which correction has not been completed yet. Therefore, the timing for displaying may be triggered by completion of correction or may be triggered by selection as a correction target.

The display module 160 may display a relationship diagram associated with a deployment table to be corrected, by using the relationship diagram ID deployment table ID relationship table 1500, and may display an item associated with an axis item to be corrected, in a form different from other items, by using the item axis item ID relationship table 1600. For example, it is possible to extract a relationship diagram ID of a relationship diagram from a deployment table ID of a deployment table by using the relationship diagram ID deployment table ID relationship table 1500. Then, it is possible to extract an item ID of a relationship diagram from an axis item ID of an axis item of a deployment table by using the item ID axis item ID relationship table 1600. Here, the “form” includes a shape (e.g., an oval shape or a square shape of a frame surrounding an item), a pattern (e.g., a pattern such as oblique lines in the background), a color (e.g., a color of a frame surrounding an item, a color of the background, or a color of a character indicating an item) or a combination thereof, or a dynamic change thereof (e.g., flash or animation). “Other items” refer to items associated with an axis item that is not a correction target. The “different form” only has to be different from the form of other items.

Then, when a correction is performed to integrate plural axis items present on one axis in a deployment table, the display module 160 may display items of a relationship diagram associated with the axis items in an integrated manner.

When causal relationship information about plural axis items to be integrated is different from that about axis items on adjacent axes, the display module 160 may display a message indicating that there is inconsistency.

The display module 160 may display a relationship diagram associated with a deployment table to be corrected, by using the relationship diagram ID deployment table ID relationship table 1500, and may display a relationship line associated with causal relationship information to be corrected, in a form different from other relationship lines, by using the relationship line ID causal relationship information ID relationship table 1700.

Then, when a correction is performed to integrate plural axis items on one axis in a deployment table, the display module 160 may display relationship lines of a relationship diagram associated with causal relationship information of the axis items in an integrated manner.

When plural relationship lines to be integrated in a relationship diagram are different in attribute information, the display module 160 may display a message that there is inconsistency.

The display module 160 may display a message of an urge to set an item or a relationship line displayed in a different form, as a correction target.

Then, when items other than an item displayed in a different form, or relationship lines other than a relationship line displayed in a different form are set as correction targets, the display module 160 may display a message that the items or the relationship lines not set as correction targets in a deployment table may be corrected.

The relationship diagram editing module 165 is connected to the association information extraction module 155, the display module 160, and the deployment table generation module 115 of the relationship diagram deployment table creation module 105. The relationship diagram editing module 165 edits a relationship diagram according to the editing operation of a user on the relationship diagram displayed by the display module 160. For example, the relationship diagram editing module 165 edits, for example, attribute information of relationship lines for which a message that there is inconsistency is displayed by the display module 160, according to the editing operation of a user. In addition, according to the editing operation of a user, editing of items (including, for example, addition and deletion), editing of attributes of an item, reassignment of a relationship line (including, for example, addition and deletion), and editing of attributes of a relationship line may be performed.

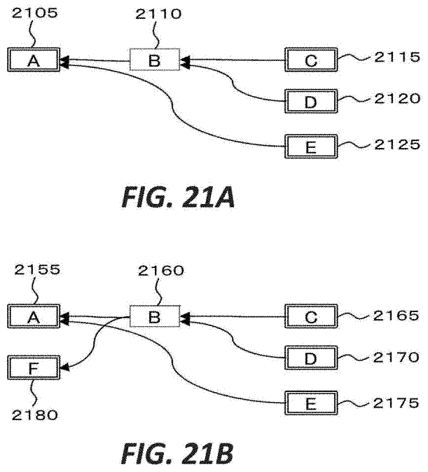

The relationship diagram editing module 165 may correct a relationship diagram corresponding to a deployment table according to correction of the deployment table by the deployment table operation receiving module 150. For example, when editing is performed on a displayed deployment table by user's operation, the deployment table is edited based on the editing, and in parallel with this, the editing result is reflected in a relationship diagram associated with the deployment table. Accordingly, it becomes possible even for a user who does not use a relationship diagram, to maintain the identity of information between the relationship diagram and a deployment table. Details of this processing will be described below by using the example in FIGS. 21A and 21B to FIGS. 27A and 27B.

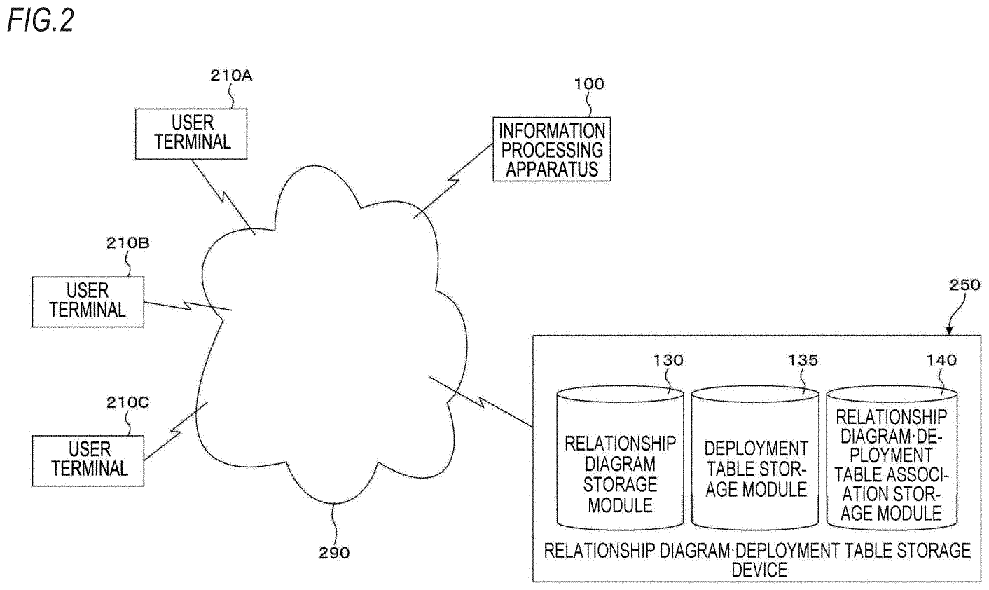

FIG. 2 is an explanatory view illustrating an example of a system configuration according to the exemplary embodiment.

The information processing apparatus 100, a user terminal 210A, a user terminal 210B, a user terminal 210C, and a relationship diagram deployment table storage device 250 are connected to each other via a communication line 290. The communication line 290 may be wireless, wired or a combination of wireless and wired communication lines, and may be, for example, the Internet or an intranet as a communication infrastructure. Functions by the information processing apparatus 100, and the relationship diagram deployment table storage device 250 may be implemented as a cloud service. The relationship diagram deployment table storage device 250 includes the relationship diagram storage module 130, the deployment table storage module 135, and the relationship diagram deployment table association storage module 140, and the information processing apparatus 100 may use the relationship diagram storage module 130, the deployment table storage module 135, and the relationship diagram deployment table association storage module 140 in the relationship diagram deployment table storage device 250 via the communication line 290, as the above-described relationship diagram storage module 130, deployment table storage module 135, and relationship diagram deployment table association storage module 140.

For example, in the information processing apparatus 100, according to user's operation in the user terminal 210A, a relationship diagram is created, and a deployment table is generated based on the relationship diagram. For example, the technique described in JP-A-2016-081185 may be used. Information on the relationship diagram is stored in the relationship diagram storage module 130 in the relationship diagram deployment table storage device 250 via the communication line 290, and information on the deployment table is stored in the deployment table storage module 135 in the relationship diagram deployment table storage device 250 via the communication line 290.

For example, a user of the user terminal 210B mainly uses a deployment table, and performs editing of the deployment table. When the editing of the deployment table is performed, the information processing apparatus 100 displays a relationship diagram associated with the deployment table, and highlights an item or a relationship line in the relationship diagram associated with an axis item or causal relationship information to be edited. Then, these are confirmed by a user, and edited in some cases. The user who performs confirmation or editing of the item or the relationship line of the relationship diagram may be a user who mainly creates and uses a relationship diagram.

The information processing apparatus 100 may be built in the user terminal 210. In this case, a stand-alone type system is configured.

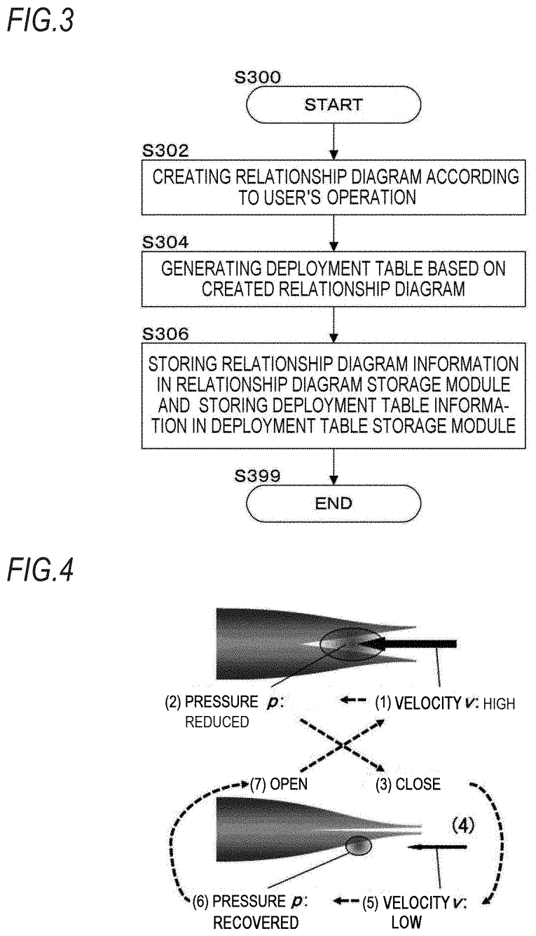

FIG. 3 is a flowchart illustrating an example of a processing according to a first exemplary embodiment (the relationship diagram deployment table creation module 105).

In step S302, the relationship diagram creation module 110 creates a relationship diagram according to user's operation.

In step S304, the deployment table generation module 115 generates a deployment table based on the created relationship diagram.

In step S306, the output module 120 stores information on the relationship diagram in the relationship diagram storage module 130, and stores information on the deployment table in the deployment table storage module 135.

Hereinafter, descriptions will be made on an example where with regard to the straw oboe mechanism, a relationship diagram is created, and a deployment table is generated, using FIGS. 4 to 8.

FIG. 4 is an explanatory view of an example of a technique which is a target of the relationship diagram and the deployment table (the straw oboe mechanism).

This technique uses the rule of hydraulic engineering which refers to the Bernoulli's theorem (see Equation 1) providing that “when a flow velocity increases, a pressure decreases.”

p+1/2ρv²=CONSTANT (p: PRESSURE r: DENSITY, v: VELOCITY) EQUATION (1)

The matter of “why does the vibration occur?” may be explained as follows. The numbers in parenthesis correspond to the numbers in parenthesis of FIG. 4.

(1) When blowing through the straw, the flow velocity inside the straw increases.

(2) When the flow velocity becomes fast, the pressure decreases.

(3) When the pressure decreases, the reed is drawn inward.

(4) When the reed is drawn inward, the flow path becomes narrow.

(5) When the flow path becomes narrow, the flow velocity becomes slow.

(6) When the flow velocity becomes slow, the pressure is recovered.

(7) When the pressure is recovered, the reed is opened.

This flow is returned to (1).

FIG. 5 is an explanatory view illustrating an example of a relationship diagram. This illustrates an example of a relationship diagram of the mechanism where the straw oboe does not sound. This is created by the relationship diagram creation module 110, according to user's operation.

As a premise, it is assumed that “the density of air is unchanged,” and “a flattening processing method is undetermined.”

In the example of FIG. 5, the respective items surrounded by rectangles are connected to each other by relationship lines. In each item, the upward arrow indicates an increase of the item, and the downward arrow indicates a decrease of the item.

The color of the relationship line between the items indicates the polarity of a causal relationship. The relationship line as a thick black line connecting the items to each other indicates that there is a positive correlation, and the relationship line as a double line (white line)connecting the items to each other indicates that there is an inverse correlation (also called a negative correlation). For example, it is described that when the item “ease of vibration” decreases, the item “ease of sounding” also decreases. The strength of an influence degree of a causal relationship may be indicated by, for example, a solid line or a broken line. These information pieces are stored in the attribute field 1120 of the relationship line information table 1100.

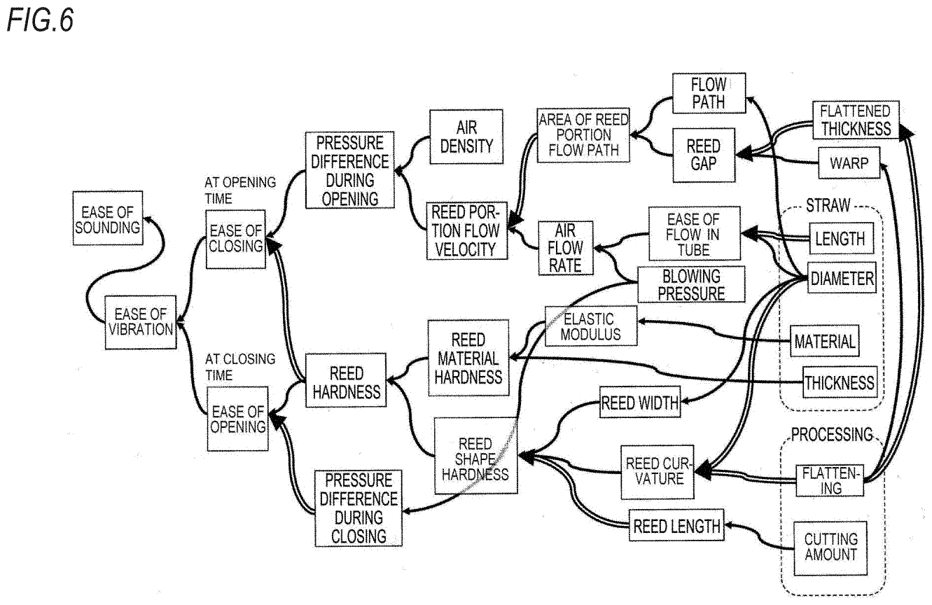

FIG. 6 is an explanatory view illustrating an example of a relationship diagram. The respective items in the relationship diagram illustrated in the example of FIG. 5 are unified into factors for an increase. That is, an example of a relationship diagram of a sound stability is illustrated. Accordingly, there are a relationship line between items of which the positive correlation becomes the inverse correlation, and inversely, a relationship line between items of which the inverse correlation becomes the positive correlation.

FIG. 7 is an explanatory view illustrating an example of a relationship diagram.

An example is illustrated in which an item to be adopted as an axis (axis item) of a deployment table is selected by user's operation. Here, “quality,” “function,” “physical,” and “design” are illustrated as a first axis, a second axis, a third axis, and a fourth axis, respectively.

An item (sound stability) 710 has been selected for the first axis.

An item (ease of closing at the opening time) 715 and an item (ease of opening at the closing time) 720 have been selected for the second axis.

An item (reed portion flow velocity) 725, an item (reed material hardness) 730, an item (reed shape hardness) 735, and an item (pressure difference during closing) 740 have been selected for the third axis.

An item (blowing pressure) 745, an item (length) 755, an item (diameter) 760, an item (thickness) 765, an item (material) 770, an item (flattening processing) 780, and an item (cutting amount) 785 have been selected for the fourth axis.

FIG. 8 is an explanatory view illustrating an example of a deployment table. This illustrates a deployment table generated from the relationship diagram illustrated in the example of FIG. 7. That is, FIG. 8 illustrates an example of a deployment table on the sound stability of a straw oboe.

The target of the deployment table is the whole or a part of a system to be developed and designed.

The first axis (quality) 810A corresponds to a quality, that is, an index of the value guaranteed to a customer. Further, the first axis (quality) 810A is an index of the value obtained as a result when the system (component) which is the target of the deployment table exhibits its function, and is an index of the value guaranteed to a customer by the system or its host system. The first axis (quality) 810A includes the axis item (sound stability) 810.

A second axis (function) 815A corresponds to a role performed by a component or a partial system in order for the system to achieve the quality. The second axis (function) 815A includes an axis item (ease of closing at the opening time) 815, and an axis item (ease of opening at the closing time) 820.

A third axis (physical) 825A corresponds to a physical quantity that determines the function exhibited by the component or the partial system. The third axis (physical) 825A includes an axis item (reed portion flow velocity) 825, an axis item (reed material hardness) 830, an axis item (reed shape hardness) 835, and an axis item (pressure difference during closing) 840.

A fourth axis (design) 845A corresponds to a setting condition for controlling a physical quantity of the component or the partial system as a target, that is, an amount and a condition that may be determined (or has to be determined) by a designer or a developer. The fourth axis (design) 845A includes an axis item (blowing pressure) 845, an axis item (straw) 850, and an axis item (processing) 875. In the axis item (straw) 850, there are an axis item (length) 855, an axis item (diameter) 860, an axis item (thickness) 865, and an axis item (material) 870. In the axis item (processing) 875, there are an axis item (flattening processing) 880, and an axis item (cutting amount) 885.

There is causal relationship information in a cell whose position is determined by adjacent axis items in the deployment table (in the example of FIG. 8, a rectangle in which, for example, the symbol ⊚, which means strong correlation, is drawn). This causal relationship information indicates a causal relationship between two axis items. The symbols “⊚” and “Δ” indicate the strength of a causal relationship, and mean “strong correlation” and “weak correlation,” respectively. The symbols “+” and “−” annexed thereto indicate the polarity of the causal relationship. That is, a positive correlation is indicated by “+,” an inverse correlation is indicated by “−,” a strong positive correlation is indicated by “⊚+” a weak positive correlation is indicated by “Δ+,” a strong inverse correlation is indicated by “⊚−,” a weak inverse correlation is indicated by “Δ−” and no relation is indicated by “−.” For example, a relationship between the axis item (sound stability) 810 and the axis item (ease of closing at the opening time) 815 is “⊚+” (strong positive correlation). Note that the meaning of these symbols applies to FIGS. 8, 19A, 20, 22A, 23A, 24A, 25A, 26A, and 27A. These information pieces are stored in the attribute field 1420 of the causal relationship information table 1400. Therefore, since the relationship line information table 1100 in the relationship diagram corresponds to the causal relationship information table 1400 in the deployment table by the relationship line ID causal relationship information ID relationship table 1700, these information pieces correspond to each other.

Since the item information table 1000 in the relationship diagram corresponds to the axis item information table 1300 in the deployment table by the item ID axis item ID relationship table 1600, these information pieces correspond to each other.

As described in the case of the above described straw oboe, in generation of a deployment table from a relationship diagram, the relationship diagram is used to clarify relationships between complicated elements by illustrating mutual relationships such as cause/result, and purpose/unit, and also includes descriptive items to encourage thinking. Meanwhile, the deployment table is used to briefly express causal relationships between respective items defined by functions of respective processes, and does not include descriptive items. Therefore, when a deployment table is generated from a relationship diagram, only required items are extracted, and the extracted items are allocated to proper axis items and reflected in the deployment table.

Here, the relationship diagram as a source that is to be converted into the deployment table is not necessarily limited to one, and a deployment table in which plural causal relationships are aggregated is also present. In such a case, plural relationship diagrams attached to the deployment table are present.

In conversion from a relationship diagram into a deployment table, a part of data pieces of the relationship diagram is used to generate the deployment table. Thus, even when the deployment table consisting of one relationship diagram is generated, irreversible conversion is performed. Thus, for the same technique as a target, there are two types of data, that is, a relationship diagram and a deployment table, and in consideration of accumulation as a technical asset, it is required to continuously maintain the consistency between the two types of data.

Thus, in the first exemplary embodiment, consistency is maintained by data association between a relationship diagram and a deployment table.

In the first exemplary embodiment, the following processes are performed. (1) In a deployment table converted from a relationship diagram, addition/deletion/correction of a factor and addition/deletion/correction of a causal relationship are performed.

When editing is performed on an item or a causal relationship between items in the deployment table, based on relationship diagram information stored as attribute information attached to the item or the causal relationship between items, the relationship diagram as a source is read and displayed. Then, a control is performed to demand confirmation or editing on the relationship diagram. The editing result in the relationship diagram is reflected in the deployment table in order to match the relationship diagram with the deployment table, and the result is displayed. Since the original data is only the relationship diagram, the consistency between the deployment table and the relationship diagram may be maintained.

In a case of a deployment table with no relationship diagram, it is possible to select whether to directly edit the deployment table or to edit a simply generated relationship diagram. In both cases, the consistency is maintained.

(2) The relationship diagram including the portion (item) or the causal relationship between items, as an editing target, is displayed, and the corresponding portion is highlighted (highlight etc,).

(3) When there are plural corresponding relationship diagrams, all the relationship diagrams are displayed. This is because there are cases where the same items and the same related causal relationships are present commonly in the plural relationship diagrams.

(4) In order to import the corresponding relationship diagram, the item and the causal relationship between items are given information on affiliation relationship diagrams. Meanwhile, as described above, the relationship diagram to be read is not limited to one.

When plural axis items are selected, editing as the same one may be performed. For example, this is performed for the purpose of merging the items.

Otherwise, items and causal relationships related to the items may be merged.

When inconsistency occurs due to merging, a presence of the inconsistency may be indicated, and editing (correction) may be demanded.

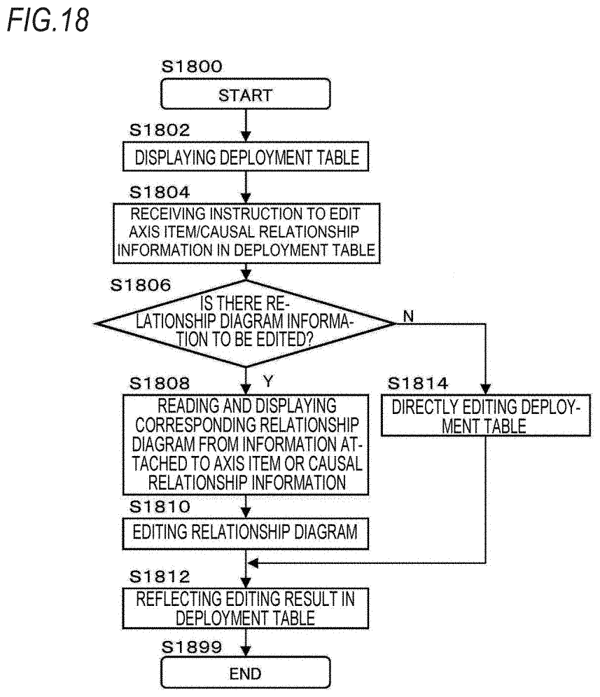

FIG. 18 is a flowchart illustrating an example of a processing according to the first exemplary embodiment.

In step S1802, the display module 160 displays a deployment table according to a display operation of a user.

In step S1804, the deployment table operation receiving module 150 receives an editing instruction of the user on an axis item/causal relationship information of the deployment table.

In step S1806, the association information extraction module 155 determines whether there is relationship diagram information to be edited. When it is determined that there is the relationship diagram information, the process proceeds to step S1808. Otherwise, the process proceeds to step S1814. That is, it is determined whether there is a relationship diagram corresponding to the deployment table (a relationship diagram as a source from which the deployment table is generated).

In step S1808, the display module 160 reads the corresponding relationship diagram from information attached to the axis item or the causal relationship information, and displays the relationship diagram.

In step S1810, the relationship diagram editing module 165 edits the relationship diagram according to user's operation.

In step S1812, the deployment table generation module 115 reflects the editing result in the deployment table.

In step S1814, the deployment table operation receiving module 150 directly edits the deployment table according to user's operation.

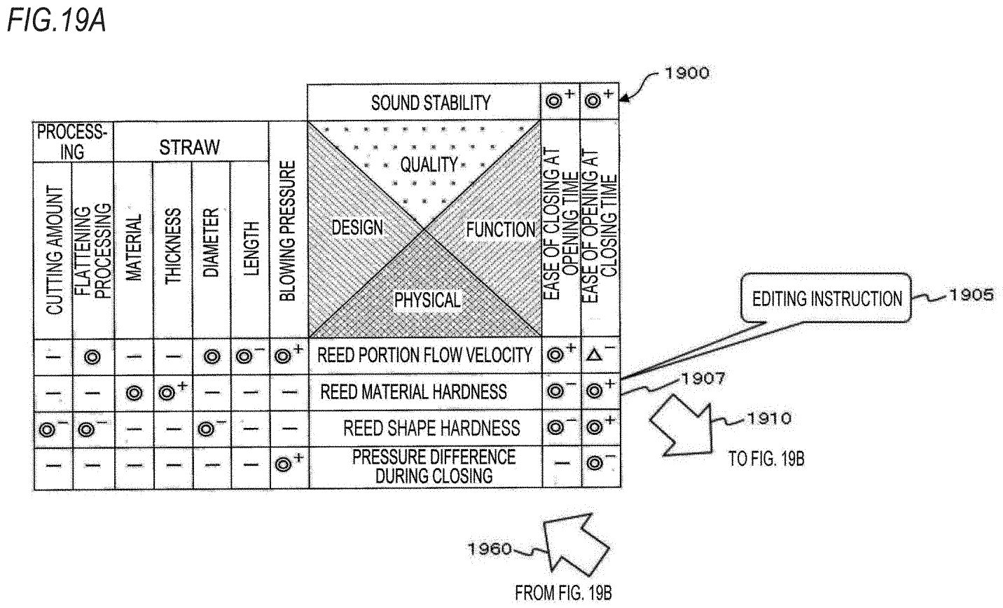

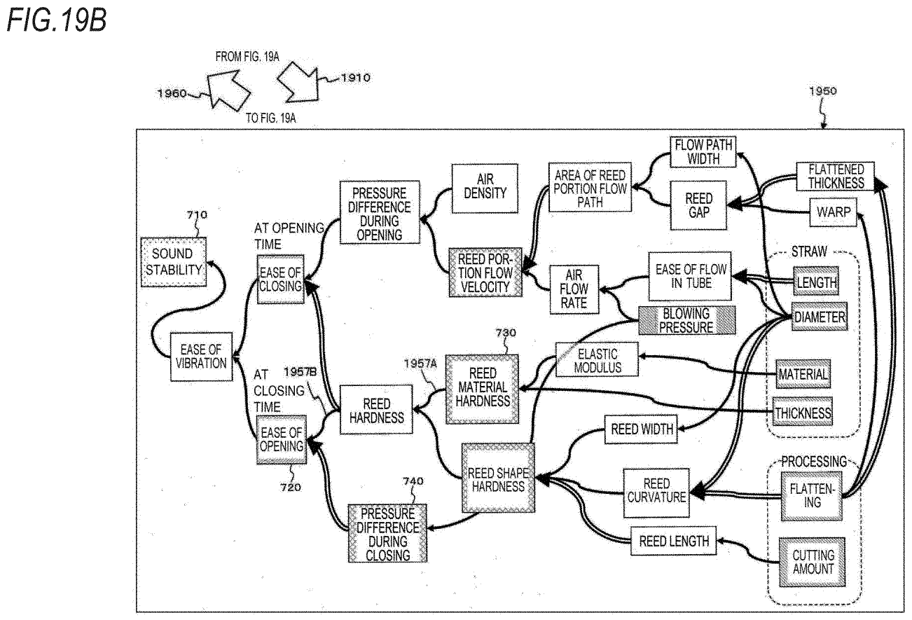

FIGS. 19A and 19B are explanatory views illustrating an example of a processing according to the first exemplary embodiment.

On a deployment table 1900, an editing instruction 1905 is performed by user's operation. The editing instruction 1905 may not indicate actual editing, but may indicate an intention of editing. By using the relationship diagram ID deployment table ID relationship table 1500, a relationship diagram 1950 corresponding to the deployment table 1900 is displayed.

Then, on the relationship diagram 1950, editing is performed by user's operation, and the editing result is reflected in the deployment table 1900.

Causal relationship information 1907 is located at the intersection between the axis item (ease of opening at the closing time) 820 and the axis item (reed material hardness) 830. The axis item (ease of opening at the closing time) 820 corresponds to the item (ease of opening at the closing time) 720, and the axis item (reed material hardness) 830 corresponds to the item (reed material hardness) 730. This correspondence relationship is managed by the item ID axis item ID relationship table 1600. Then, the causal relationship information 1907 corresponds to a relationship line 1957A and a relationship line 1957B. This correspondence relationship is managed by the relationship line ID causal relationship information ID relationship table 1700.

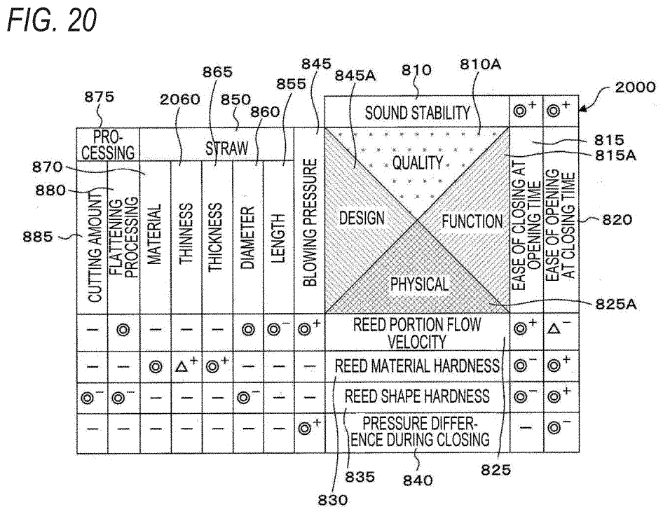

FIG. 20 is an explanatory view illustrating an example of a processing according to the first exemplary embodiment.

On a deployment table 2000, when plural axis items e.g., the axis item (ease of closing at the opening time) 815 and the axis item (ease of opening at the closing time) 820) are selected by user's operation, editing as the same axis item is performed (items are merged). Alternatively, items and causal relationship information pieces related to the items may be merged.

Specifically, in the deployment table 2000, there is “thinness” indicating the same concept as “thickness” (the axis item (thickness) 865, and an axis item (thinness) 2060). When the axis item (thickness) 865 and the axis item (thinness) 2060 are selected, relationship diagrams corresponding to the items, respectively, are read, and any one of the following processes is performed by selection. (1) One side (e.g., the relationship diagram) is edited, and thus the editing result is reflected in the other side (e.g., the deployment table). (2) With the same concept, items (or axis items) are integrated and associated with each other.

Meanwhile, in the case of merging (that is, items are treated as the same), when inconsistency occurs in a causal relationship, it is described that it is impossible to consider the items as the same due to the presence of inconsistency, and correction editing is demanded. For example, in the relationship diagram of the deployment table 2000, there is a positive causal relationship between the axis item (thickness) 865 and the axis item (reed material hardness) 830, whereas there is an inverse causal relationship between the axis item (thinness) 2060 and the axis item (reed material hardness) 830. Thus, it is determined that there is inconsistency. The inconsistency may be determined for one deployment table, or the inconsistency occurring between plural deployment tables may be determined. For example, this corresponds to a case where when an axis item (thickness) is merged with an axis item (thinness), in one deployment table, there is a positive causal relationship between the axis item (thickness) and an axis item (reed material hardness), whereas in the other deployment table, there is an inverse causal relationship between the axis item (thinness) and the axis item (reed material hardness). As the corresponding example, there may also be a case where one causal relationship is a positive (strong) causal relationship, and the other causal relationship is a positive (weak) causal relationship. These two deployment tables correspond to one relationship diagram (that is, from the one relationship diagram, two deployment tables have been created).

When there is a correction instruction for a deployment table (for the instruction, actual correction does not need to be performed), a relationship diagram corresponding to the deployment table is displayed, and editing is demanded.

However, there is also a user who does not use a relationship diagram, but handles only a deployment table. For such a user, editing of the relationship diagram is a demand for originally unnecessary editing (that is, a load for the user). In the first exemplary embodiment, editing may also be included in the use by a user who creates a deployment table based on a relationship diagram, and a user who uses only a deployment table.

That is, for example, in a case where a user mainly using a deployment table and a user mainly using a relationship diagram are mixed, and edit a deployment table for the same technique, since for the user mainly using the deployment table, it is not necessary to edit the relationship diagram, and the relationship diagram is used to maintain the consistency.

Descriptions will be made on a case where a deployment table is actually corrected and the correction result is reflected in a relationship diagram, with reference to the example illustrated in FIGS. 21A and 21B to FIGS. 27A and 27B.

FIGS. 21A and 21B are explanatory views illustrating an example of a processing according to the first exemplary embodiment.

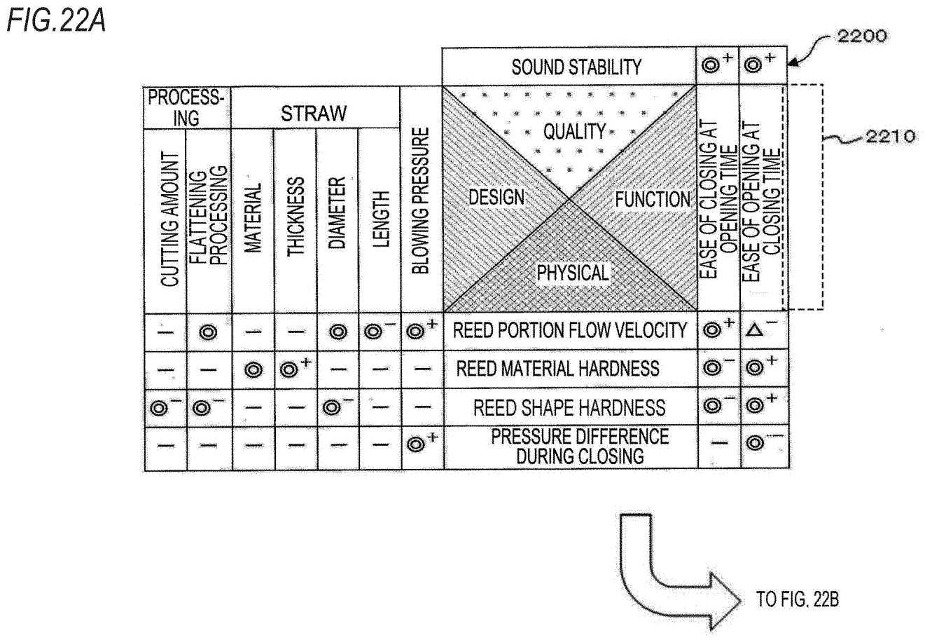

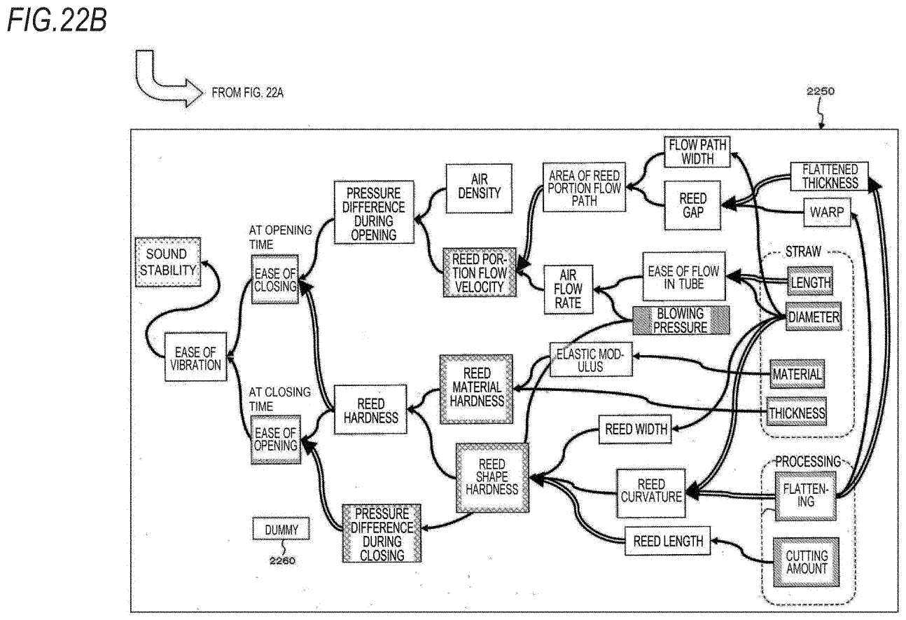

A method of reflecting a correction result of a deployment table in a relationship diagram is as follows. On an edited portion, the fact that the editing has been made may be stated and the history may be left.
(A1) Addition of an axis item (factor) in a deployment table (see the example of FIGS. 22A and 22B)

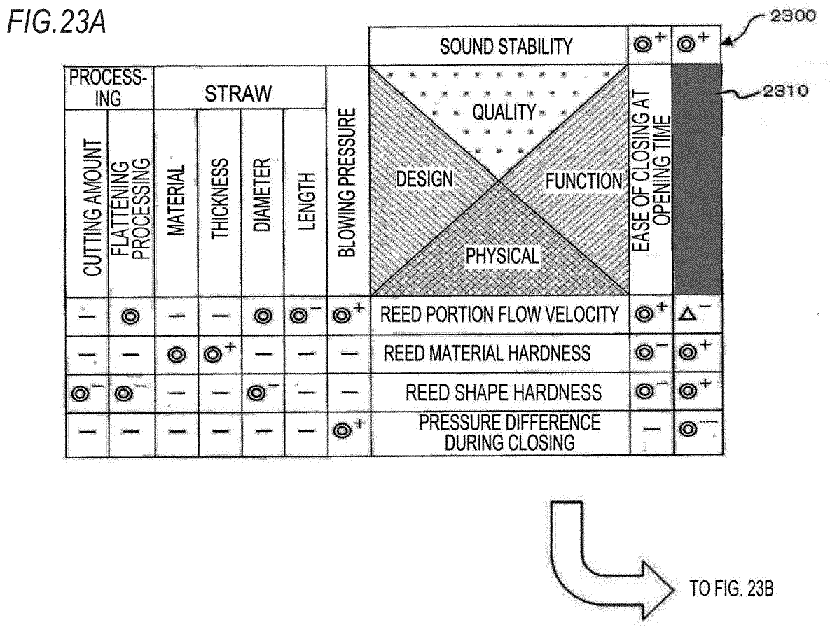

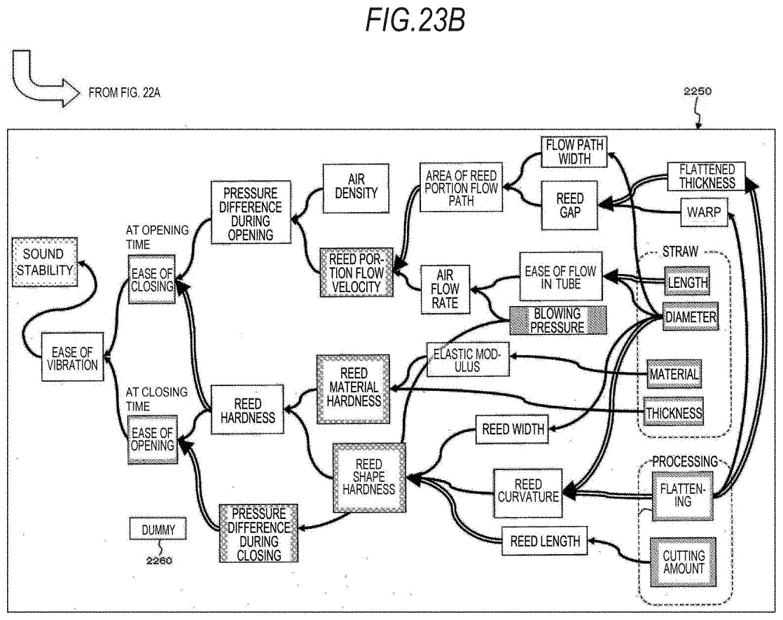

A dummy item (factor) is added to a corresponding portion of a relationship diagram to which the axis item (factor) is to be added.
(A2) Deletion of an axis item (factor) in a deployment table (see the example of FIGS. 23A and 23B)

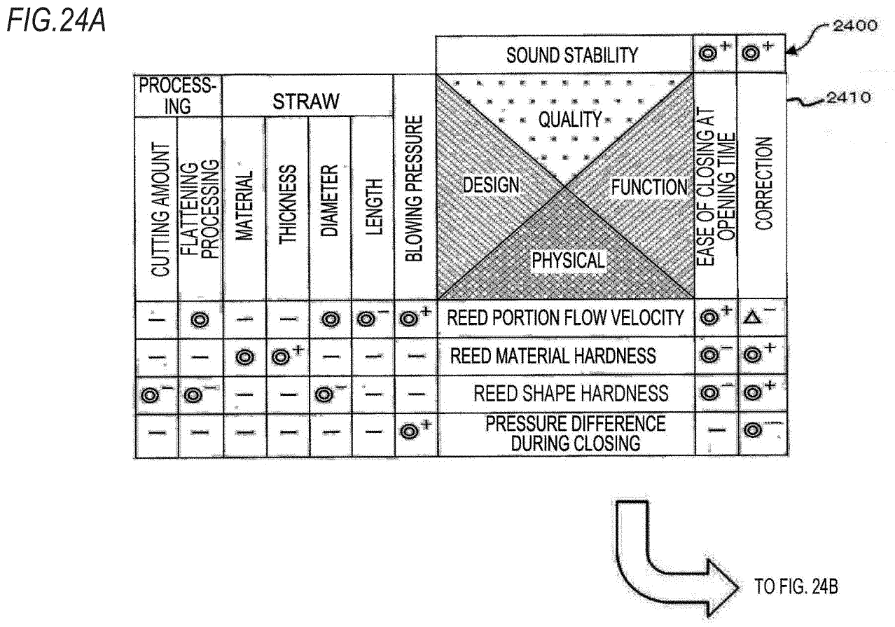

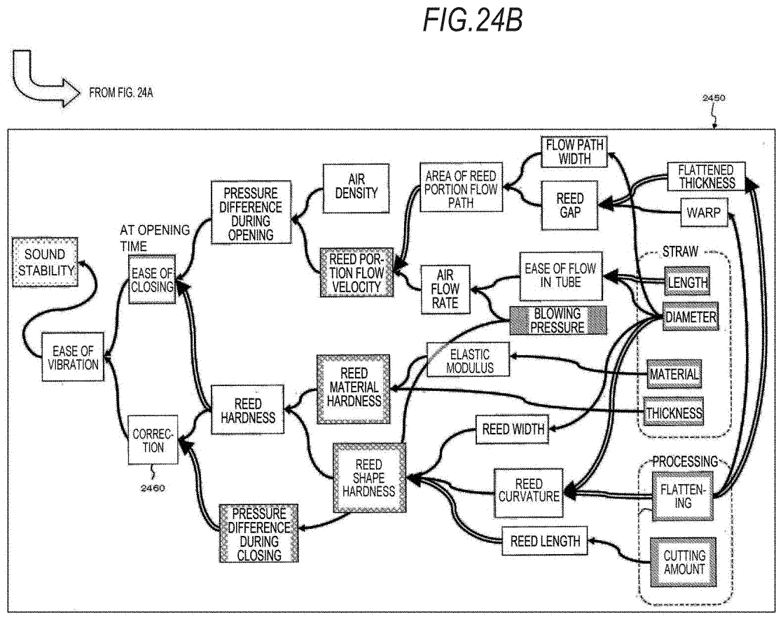

A dummy item (factor) is left at a portion of a relationship diagram corresponding to the deleted axis item (factor).
(A3) Correction of an axis item (factor) in a deployment table (see the example of FIGS. 24A and 24B)

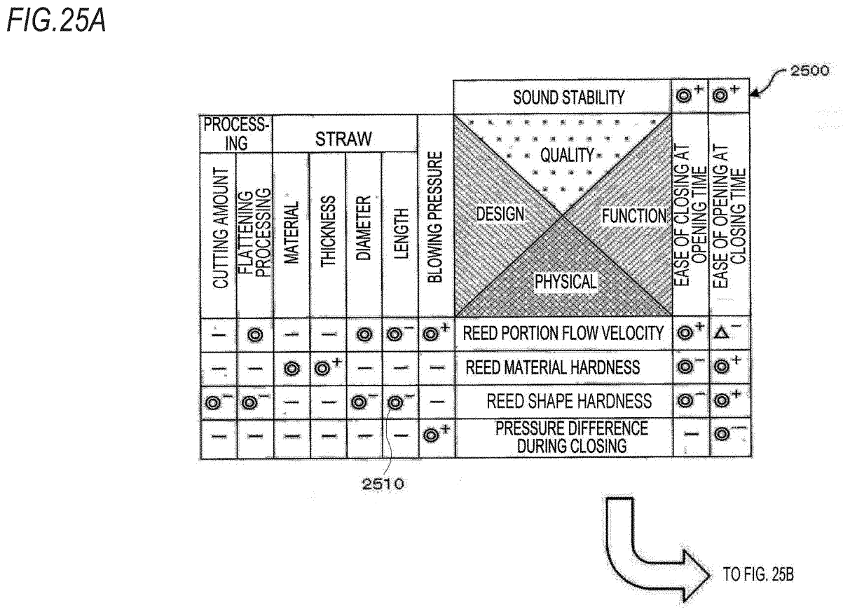

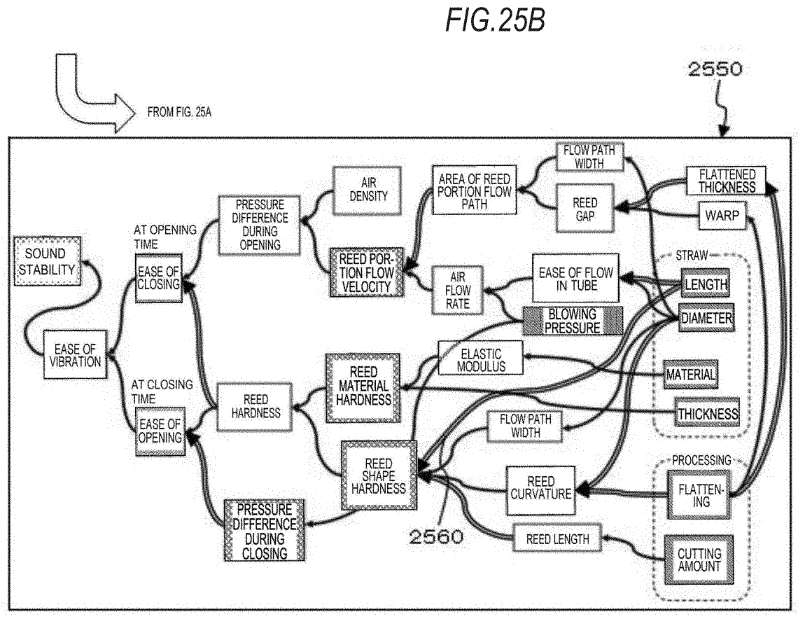

The correction is reflected in a portion of a relationship diagram corresponding to the corrected axis item (factor).
(B1) Addition of causal relationship information in a deployment table (see the example of FIGS. 25A and 25B)

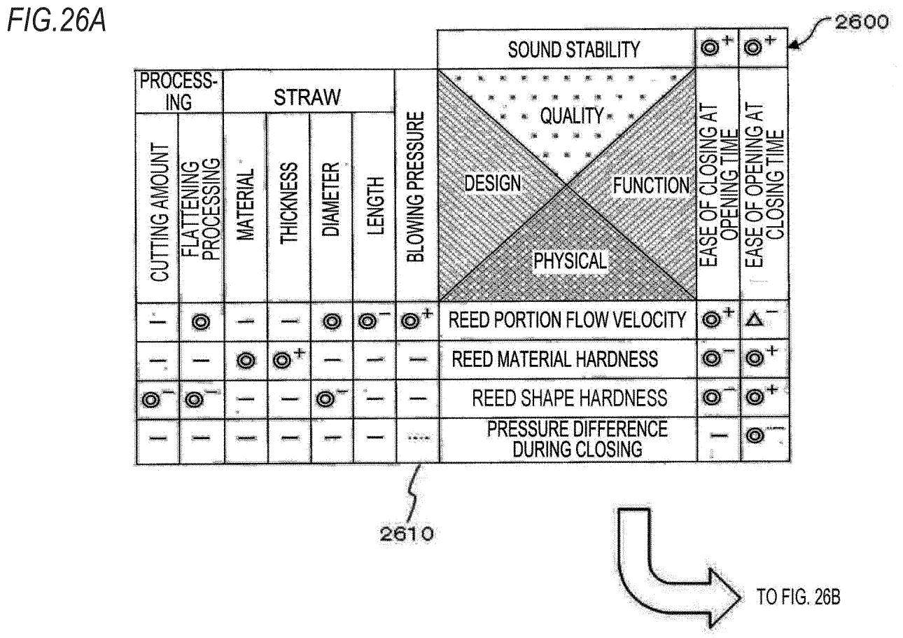

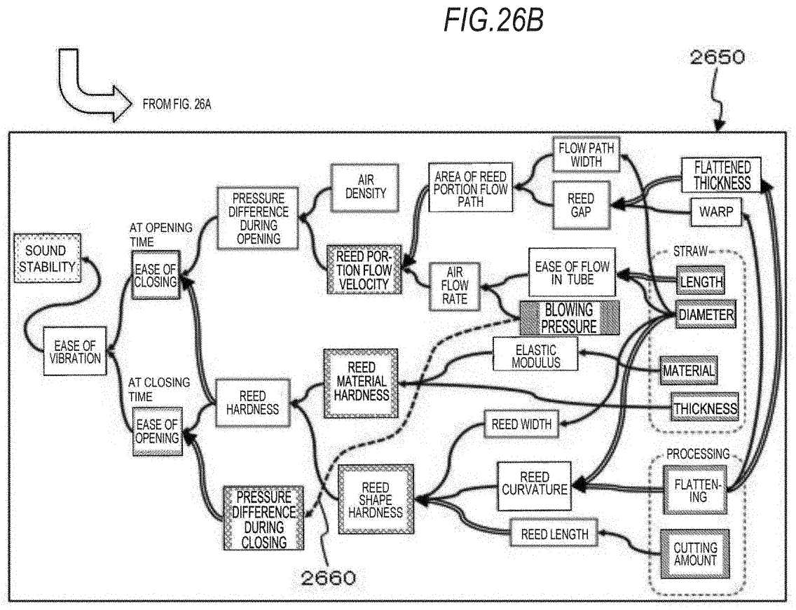

A portion of a relationship diagram corresponding to the causal relationship information between axis items is added.
(B2) Deletion of causal relationship information in a deployment table (see the example of FIGS. 26A and 26B)

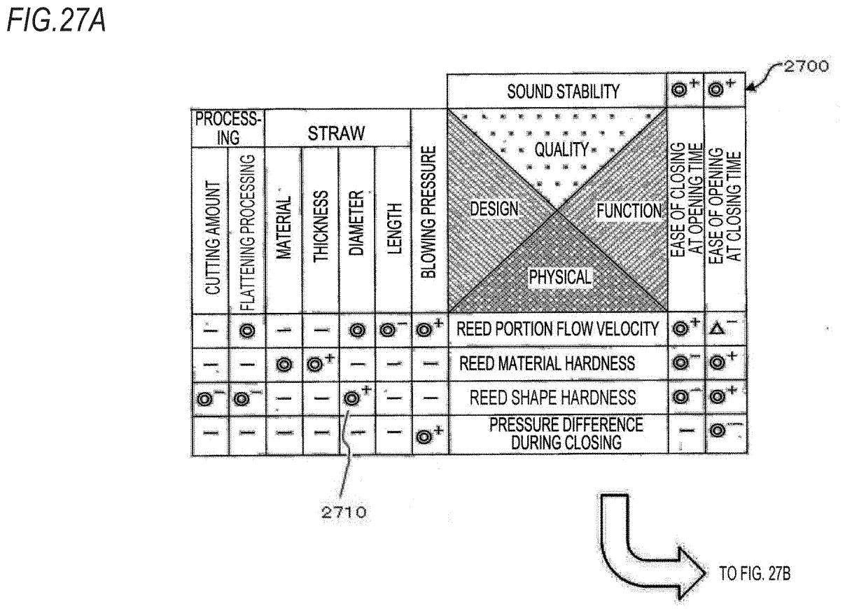

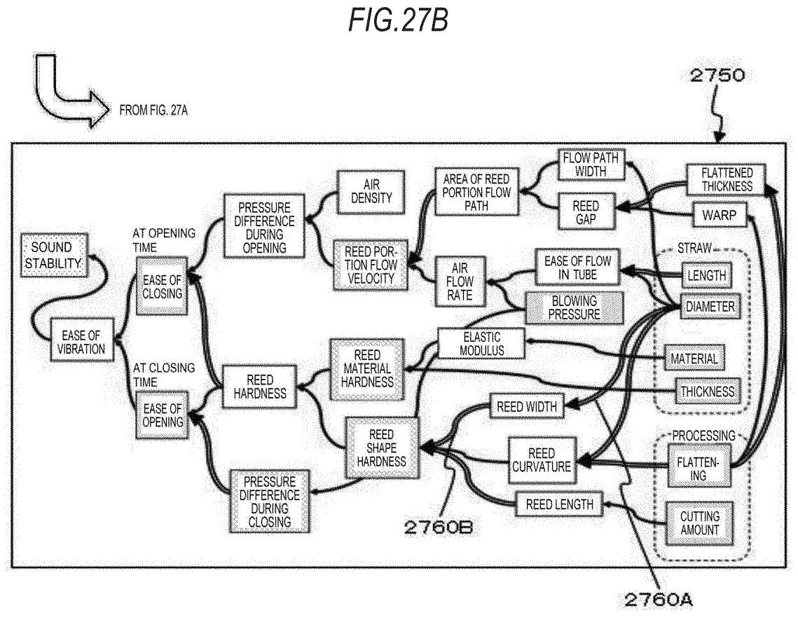

A portion of a relationship diagram corresponding to the causal relationship information between axis items is deleted.
(B3) Correction of causal relationship information in a deployment table (see the example of FIGS. 27A and 27B)

A portion of a relationship diagram corresponding to the causal relationship information between axis items is corrected.

Editing is performed within a range that does not affect an already set causal relationship. However, in a case of deletion/correction, other causal relationships are affected. Thus, in a case where inconsistency occurs, a message on occurrence of the inconsistency is displayed, and editing is not performed. Here, the case where the inconsistency occurs corresponds to a case where an element is present between axis items, and the element has a direct or indirect causal relationship with another axis item. As to whether inconsistency occurs, an edited deployment table A is compared to a deployment table B generated from a relationship diagram created from the deployment table A. Then, when there is a difference, it may be determined that the inconsistency has occurred.

In the example of a relationship diagram in FIG. 21A, a connection is made from an item C 2115 toward an item B 2110, a connection is made from toward an item D 2120 toward the item B 2110, a connection is made from the item B 2110 toward an item A 2105, and a connection is made from an item E 2125 toward the item A 2105.

In the example of a relationship diagram in FIG. 21B, a connection is made from an item C 2165 toward an item B 2160, a connection is made from an item D 2170 toward the item B 2160, a connection is made from the item B 2160 toward an item A 2155, a connection is made from the item B 2160 toward an item F 2.180, and a connection is made from an item E 2175 toward the item A 2155.

For example, in FIG. 21A., it is assumed that the item A 2105, the item C 2115, the item D 2120, and the item E 2125 are set as axis items. Even when a causal relationship between the item A 2105 and the item E 2125 is deleted/corrected, others are not affected. However, in a case where a causal relationship between the item A 2105 and the item D 2120 is deleted/corrected, when a causal relationship between the item A 2105 and the item B 2110 is deleted/corrected, a causal relationship between the item A 2105 and the item C 2115 is affected. In such a case, a causal relationship between the item B 2110 and the item D 2120 is deleted/corrected.

Meanwhile, in the case of FIG. 21B, in a case where a causal relationship between the item A 2155 and the item D 2170 is deleted, even when any causal relationship is deleted/corrected, another causal relationship is affected. Thus, a message that it is not possible to perform deletion/correction is displayed. Alternatively, a relationship diagram may be displayed, and editing may be demanded.

FIGS. 22A and 22B are explanatory views illustrating an example of a processing (an additional example of an axis item (factor) in a deployment table) according to the first exemplary embodiment.

In a deployment table 2200, a new axis item 2210 is added to a function axis of the deployment table 1900.

In this case, as illustrated in the example of a relationship diagram 2250, a new item (dummy) 2260 is added. The arrangement position of the new item (dummy) 2260 is set to the vicinity of items in the relationship diagram 2250, which correspond to other axis items (ease of closing at the opening time, ease of opening at the closing time) on the function axis.

For a user using only the deployment table 2200, the relationship diagram 2250 may not be displayed. The determination as to whether a user uses only the deployment table 2200 may be made based on the past history (whether a relationship diagram was displayed), or may be made based on attributes of the user (e.g., attributes indicating whether the user uses a relationship diagram, or a job type of the user).

FIGS. 23A and 23B are explanatory views illustrating an example of a processing (an example of a deletion of an axis item (factor) in a deployment table) according to the first exemplary embodiment.

A deployment table 2300 is obtained by deleting a symmetry axis item 2310 from a function axis in the deployment table 1900 exemplified in FIGS. 19A and 19B.

In this case, as illustrated in the example of a relationship diagram 2350, the deleted axis item (factor) is left as a target item (dummy) 2360.

FIGS. 24A and 24B are explanatory views illustrating an example of a processing (an example of a correction of an axis item (factor) in a deployment table) according to the first exemplary embodiment.

A deployment table 2400 is obtained by correcting a symmetry axis item (correction) 2410 that is an axis item (element) in a function axis of the deployment table 1900.

In this case, as illustrated in the example of a relationship diagram 2450, a target item (correction) 2460 corresponding to the symmetry axis item (correction) 2410 may be corrected.

FIGS. 25A and 25B are explanatory views illustrating an example of a processing (an example of an addition of causal relationship information in a deployment table) according to the first exemplary embodiment.

In a deployment table 2500, causal relationship information present at the intersection between “length” and “reed shape hardness” of the deployment table 1900 is changed from “−” to “⊚−” (new causal relationship information 2510) (this corresponds to addition of causal relationship information).

In this case, as illustrated in the example of a relationship diagram 2550, a relationship line 2560 is added. The relationship line 2560 is a relationship line that connects an item “length” to an item “reed shape hardness.”

FIGS. 26A and 26B are explanatory views illustrating an example of a processing (an example of a deletion of causal relationship information in a deployment table) according to the first exemplary embodiment.

In a deployment table 2600, causal relationship information present at the intersection between “blowing pressure” and “pressure difference during closing” of the deployment table 1900 is changed from “⊚+” to “−” (target causal relationship information 2610) (this corresponds to deletion of causal relationship information)

In this case, as illustrated in the example of a relationship diagram 2650, a target relationship line 2660 is deleted. When another causal relationship is affected, a corresponding message may be displayed so that deletion may not be allowed.

FIGS. 27A and 27B are explanatory views illustrating an example of a processing (an example of a correction of causal relationship information in a deployment table) according to the first exemplary embodiment.

In a deployment table 2700, causal relationship information present at the intersection between “diameter” and “reed shape hardness” of the deployment table 1900 is changed from “⊚−” to “⊚+” (target causal relationship information 2710) (this corresponds to correction of causal relationship information).

In this case, as illustrated in the example of a relationship diagram 2750, a target relationship line 2760A and a target relationship line 2760B corresponding to the target causal relationship information 2710 are corrected. When another causal relationship is affected, a corresponding message may be displayed so that correction may not be allowed.

### Second Exemplary Embodiment

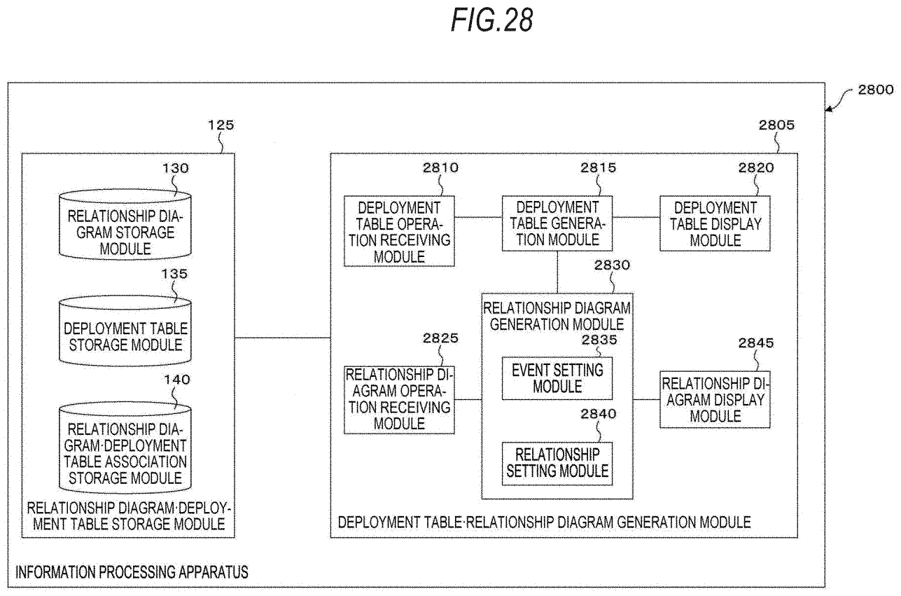

Prior to explanation of the second exemplary embodiment, descriptions will be made on a background of a deployment table and a relationship diagram. In particular, this explanation (from this paragraph to explanation using FIG. 28) is intended to facilitate the understanding of the second exemplary embodiment, and it is not intended to limit interpretation by using this explanation. Then, it is natural that using only this explanation part, it should not be determined that the disclosure to be patented is described in the detailed description of the disclosure.

In particular, in complicated causal relationships such as a relationship between a design and a quality in a system using complex physical phenomena, in general, many events are linked to each other in a chain-like manner, in which, for example, for the result such as a final quality of a product, there are plural events that become factors of the result, there are plural events that become factors from which these events are generated as a result, there are plural events that become factors from which the events are generated as a result, and. . . . In such a complicated system, since there are many qualities that have to be satisfied, causal relationships between a design group and a quality group become highly complicated. This tends to cause a problem that it is difficult to find a design item to satisfy a desired quality, or it is difficult to find that a change in a design value to satisfy a certain quality adversely affects another quality. Here, the factor refers to an event that may become a cause of a certain event.

There are several ways to visualize and organize such complicated causal relationships. Representative examples include (1) a relationship diagram in which relationship lines connect results to their factors so as to express causal relationships (a logic tree is typical), and (2) a deployment table in which relationships between events listed on plural axes orthogonal to each other are indicated by symbols or numerical values arranged in a matrix. The deployment table is not necessarily limited to a table in which relationships between qualities and functions are developed. The relationship diagram is suitable for illustrating results and their factors in detail without a jump in logic and omission/redundancy. In the deployment table, among many events, important things are extracted and arranged on axes, and then causal relationships are expressed in a matrix. Thus, relationships between many results and many factors may be simply expressed.

It is possible to describe the relationship diagram in detail by considering causal relationships between events. Meanwhile, when the number of events as targets excessively increases, the diagram becomes excessively complicated, and becomes hypertrophic. Thus, creation becomes difficult, and visibility of the causal relationships is also deteriorated. In the deployment table, since important events are extracted and arranged on axes so as to express causal relationships, it is not possible to express detailed causal relationships involving events not arranged on the axes. Further, as a result, missing of events to be considered is likely to occur. In a generally widely made deployment table, since a factor and a result are merely arranged on two axes (a horizontal axis and a vertical axis), respectively, it is not possible to give information on why such a relationship is made at the very beginning. Meanwhile, a multiaxial quality function development is effective in which three or more axes are arranged perpendicular to each other, and among factors constituting causal relationships, important things are extracted and described so as to schematically express the causal relationships.

From the above, the relationship diagram and the multiaxial deployment table may be used in combination so that mainly in the relationship diagram, it is possible to extract and describe causal relationships in detail without a jump in logic or omission/redundancy, and mainly in the deployment table, it is possible to briefly display relationships between a large number of factors and results. However, conversion between the relationship diagram and the deployment table is complicated, and thus for such a purpose, a system supporting the conversion becomes necessary.

There is already a system that draws a relationship diagram in which causal relationships are hierarchized, and selects hierarchies so as to display a biaxial deployment table. However, in order to create a relationship diagram in a hierarchized state, at a point in time the relationship diagram is created by considering relationships between events, causal relationships need to be organized in a hierarchical manner. However, it is difficult to organize hierarchies of the causal relationships while investigating the relationships between the events without a jump in logic and omission/redundancy. In the idea of “classifying factors into hierarchies,” each event has to belong to any one of hierarchies, and thus it is not possible to achieve the purpose of “extracting and displaying important factors.” As a result, at the time of displaying on a deployment table, problems are likely to occur in which the number of events displayed on one axis excessively increases, or more complicated causal relationships occur between events displayed on one axis so as to cause confusion.

In order to address such a problem, in JP-A-2016-081185, there is proposed a technique in which in a created relationship diagram, events corresponding to respective axes of a deployment table are selected and then deployed on the deployment table.

In some cases, the strength of a relationship between the respective events may be represented by, for example, the thickness or type of a relationship line in a relationship diagram or the type of a symbol displayed on a matrix in a deployment table. However, in order to more accurately express a causal relationship, it is effective to display not only the presence/absence of the relationship or the strength of the relationship, but also how an event changes when a certain factor changes. In particular, in investigating factors, thinking what happens when a factor increases rather than simply determining that “there is a relationship” is helpful in understanding. In developing and designing a system, it is necessary to determine a design value so as to improve a quality and to address a quality problem. Thus, it is far more useful to know a direction, that is, which direction a design value is to be changed, rather than the presence/absence of a relationship between a design value and a quality. That is, for example, whether a result increases or decreases when a factor increases has to be described.

In a relationship diagram, in many cases, it is desirable to describe the relationship between event changes. For example, with respect to a hay fever mask, for example, “filter gap” and “pollen passage rate” may not be written, but for example, “make a filter gap finer” and “a pollen passage rate decreases” are written and connected by an arrow so as to express a relationship that “by making a filter gap finer, a pollen passage rate decreases.” However, meanwhile, for example, there is also a case where it is necessary to perform writing with an inversed large/small relationship such as “make a filter gap rough” and then “become easy to breathe.” Then, writing may become difficult or wrong, thereby causing confusion in a causal relationship. Therefore, it is required to use a predetermined term.

In a deployment table, an upward or downward arrow may be used as a symbol when a relationship between events is displayed in a matrix. That is, there is a case where an increase/decrease relationship is indicated by the type of a symbol. Here, in the deployment table, as an axis item, an amount itself is generally described instead of the magnitude of the amount. Thus, it is common to think about the correlation between events assuming that each amount “increases.” Thus, when a relationship diagram and a deployment table are converted into each other, inconsistency occurs. An event denoted by “soft” in a relationship diagram may need to be denoted by “stiff” in a deployment table. That is, in some cases, terms having opposite meanings need to be used in the relationship diagram and the deployment table.

FIG. 28 is a schematic module diagram of an example of a configuration according to the second exemplary embodiment.

The same portions as those of the first exemplary embodiment are denoted by the same reference numerals and redundant explanations thereof will be omitted. The first exemplary embodiment and the second exemplary embodiment may be combined with each other.

The “correction” includes change and deletion of original information, and addition of new information.

An “element” is an element constituting a relationship diagram, corresponds to an event (also referred to as a box), and a relationship line (also referred to as a connection line) as described above, and corresponds to a node (node, vertex) and an edge (branch, side, connector) in a graph theory. For example, when an item on an axis in a deployment table is corrected, an event in a relationship diagram corresponding to the corrected item is corrected, and then the corrected event is converted into a form different from that of the uncorrected event. When a symbol or a nwnerical value arranged in a matrix of a deployment table is corrected, a relationship line in a relationship diagram corresponding to the corrected symbol or the corrected nwnerical value is corrected, and then the corrected relationship line is converted into a form different from that of the uncorrected relationship line.

The “change,” “increase/decrease,” and “occurrence tendency” will be described below. Examples of the “event” include “an increase (large) in speed” and “a decrease (small) in time.” These examples are used to make specific descriptions.

The “high” in “high speed” or “decrease” in “a decrease in time” is a “change” in an event, and the direction or tendency thereof corresponds to “how the event changes.”

Therefore, an occurrence of an event is expressed as “a change in an event.” This does not indicate becoming a different event, such as a change from an “increase in speed” to “a decrease in speed” or to an “increase in acceleration.”

The “change in an event” may include, for example, “material change” and “an increase and then decrease in speed.” “Increase/decrease” is a part (lower concept) of “change.” “Increase/decrease” may include an event represented by an expression indicating a state rather than another change indicating the magnitude of a variable such as “long and short,” or a change such as “large and small.”

The “speed” and “time” are strictly “variables.” However, in a relationship diagram or a deployment table, a description “speed”→“time” indicates a relationship between events, that is, “when a speed changes, a time also changes” or “when a speed is high, a time also becomes long.” Thus, it may be thought that even description of only variables indicates an “event.”

A case where when an event A occurs, an event B also occurs means that “the tendencies of occurrence of the events are similar to each other.” A case where when an event A occurs, an event opposite to an event B occurs means that “the tendencies of occurrence of the events are opposite to each other.”

A display module (a deployment table display module 2820, a relationship diagram display module 2845) may take any of forms, that is, (1) a display module that includes a display device, and causes the display device to display a target (a relationship diagram, a deployment table) and (2) a display control module that performs a control to display a target on a display device (a control module not including the display device itself).

When a relationship diagram is corrected, a generation module (a deployment table generation module 2815, a relationship diagram generation module 2830) may correct a deployment table corresponding to the relationship diagram. Then, a display module may display an element in the deployment table corrected by the generation module, in a form different from that of an uncorrected element. The display module may display, an element in the deployment table corrected by the generation module, in the same form as that of the uncorrected element.

An information processing device 2800 includes a relationship diagram deployment table storage module 125, and a deployment table relationship diagram generation module 2805.

The relationship diagram deployment table storage module 125 includes a relationship diagram storage module 130, a deployment table storage module 135, and a relationship diagram deployment table association storage module 140, and is connected to the deployment table relationship diagram generation module 2805.

The deployment table relationship diagram generation module 2805 includes a deployment table operation receiving module 2810, the deployment table generation module 2815, the deployment table display module 2820, a relationship diagram operation receiving module 2825, the relationship diagram generation module 2830, and the relationship diagram display module 2845, and is connected to the relationship diagram deployment table storage module 125. The deployment table relationship diagram generation module 2805 performs a processing related to correction of a deployment table or a relationship diagram.

The deployment table operation receiving module 2810, the deployment table generation module 2815, and the deployment table display module 2820 perform a processing (e.g., creation, correction, or displaying) on a deployment table in which relationships between items listed on plural (particularly, three or more) axes perpendicular to each other are indicated by symbols or numerical values arranged in a matrix.

The relationship diagram operation receiving module 2825, the relationship diagram generation module 2830, and the relationship diagram display module 2845 perform a processing (e.g., creation, correction, or displaying) on a relationship diagram (a tree diagram is typical) in which relationship lines connect events to each other so as to express relationships.

Then, the deployment table generation module 2815 and the relationship diagram generation module 2830 select an event in a relationship diagram corresponding to an axis of a deployment table so as to give a correspondence relationship to the two, and perform a processing such as mutual conversion. In the mutual conversion processing, the above described technique described in, for example, JP-A-2016-081185 may be used. Techniques other than the technique described in, for example, JP-A-2016-081185 will be mainly described below.

The deployment table operation receiving module 2810 is connected to the deployment table generation module 2815. The deployment table operation receiving module 2810 receives a correcting operation of a user on a deployment table displayed by the deployment table display module 2820.

The deployment table generation module 2815 is connected to the deployment table operation receiving module 2810, the deployment table display module 2820, and the relationship diagram generation module 2830. The deployment table generation module 2815 corrects the deployment table according to the correcting operation received by the deployment table operation receiving module 2810.

Otherwise, when a relationship diagram is corrected by the relationship diagram generation module 2830, the deployment table generation module 2815 corrects a deployment table corresponding to the relationship diagram.

The deployment table display module 2820 is connected to the deployment table generation module 2815. The deployment table display module 2820 displays the deployment table corrected by the deployment table generation module 2815, on a display device, such as a liquid crystal display.

The relationship diagram operation receiving module 2825 is connected to the relationship diagram generation module 2830. The relationship diagram operation receiving module 2825 receives a correcting operation of a user on a relationship diagram displayed by the relationship diagram display module 2845.

The relationship diagram generation module 2830 includes an event setting module 2835, and a relationship setting module 2840, and is connected to the deployment table generation module 2815, the relationship diagram operation receiving module 2825, and the relationship diagram display module 2845. The relationship diagram generation module 2830 corrects the relationship diagram according to the correcting operation received by the relationship diagram operation receiving module 2825. Then, when a deployment table is corrected by the deployment table generation module 2815, the relationship diagram generation module 2830 corrects a relationship diagram corresponding to the deployment table.

The event setting module 2835 sets how an event in a relationship diagram changes. The increase or decrease of an event may be set according to user's operation (setting either increase or decrease for each event), and either a predetermined increase or decrease for an event may be set. In the latter case, for example, there is a predetermined rule (rule) “set “increase” for an event of “heating portion diameter” and then setting may be made according to the rule. “Increase or decrease of an event” includes, for example, that a value of an event is large or small.

With respect to a relationship line connecting events to each other, the relationship setting module 2840 sets that a change in one event is related to a change in the other event, or that a change relationship is not specifiable, between two events connected by the relationship line. According to user's operation (setting that a change relationship is either present or unknown between two events connected by a relationship line), it is possible to set that a change relation between events is either present or unknown. Otherwise, for a combination of two events, it is possible to set that a change relationship between events is either present or unknown. For the latter case, for example, there is a predetermined rule (rule) “set “a change relationship is present” for two events “heating portion diameter (increase),” “capacity of heating portion (increase)””, and then setting may be made according to the rule.

In this case, the fact that “a change in one event is related to a change in the other event” may include the fact that “the tendency of occurrence of one event is similar or opposite to the tendency of occurrence of the other event.” In this case, there are three types of second settings: (1) the tendency of occurrence of one event is similar to the tendency of occurrence of the other event, (2) the tendency of occurrence of one event is opposite to the tendency of occurrence of the other event, and (3) there is no specifiable relationship between the tendencies of a change in one event and a change in the other event.

The expression “the tendencies of occurrence of two events are similar to each other” means that when one event occurs, the other event also occurs. The expression “the tendencies of occurrence of two events are opposite to each other” means that when one event occurs, an event opposite to the other event occurs. For example, for an event “a speed increases” and an event “a time required for arrival decreases,” since the required time is shortened as the speed increases, occurrence tendencies are coincident. For example, when two events are considered as “an increase in speed” and “an increase in the time required for arrival,” the tendencies of occurrence of the two events are opposite to each other.

The “occurrence tendencies of events are coincident” is not necessarily limited to coincidence of events in increase/decrease. For example, since a required time decreases as a moving speed to a destination increases, occurrence tendencies of events “a speed increases” and “a time decreases” are coincident. However, an increase or decrease in “speed” is opposite to an increase or decrease in “time.”

The relationship diagram display module 2845 is connected to the relationship diagram generation module 2830. The relationship diagram display module 2845 displays a relationship diagram corrected by the relationship diagram generation module 2830, on a display device such as a liquid crystal display.

The relationship diagram display module 2845 may display a relationship line indicating that one event is related to the other event and a relationship line indicating that a relationship is not specifiable, in a distinguishable manner according to the setting by the relationship setting module 2840.

With respect to a relationship line connecting events to each other, the relationship setting module 2840 may also determine that the tendency of occurrence of one of the two events connected by the relationship line is similar or opposite to the tendency of occurrence of the other event.

In this case, the term “similar” may be intended to include two cases: (1) a case where when one event occurs, the other event also occurs and (2) a case where when an event opposite to one event occurs, an event opposite to the other event occurs.

The term “opposite” may be intended to include two cases: (1) a case where when one event occurs, an event opposite to the other event occurs and (2) a case where when an event opposite to one event occurs, the other event occurs.

In such a case, the relationship diagram display module 2845 may also display a relationship line according to the setting by the relationship setting module 2840 in such a way that a relationship line indicating that the tendency of occurrence of one event is similar to the tendency of occurrence of the other event is distinguishable from a relationship line indicating that the tendency of occurrence of one event is opposite to the tendency of occurrence of the other event.

With respect to a relationship line connecting events to each other, the relationship setting module 2840 may determine that the tendency of occurrence of one of two events connected by the relationship line is similar or opposite to the tendency of occurrence of the other event.

In such a case, the relationship diagram display module 2845 may display a relationship line according to the setting by the relationship setting module 2840 in such a way that a relationship line indicating that the tendency of occurrence of one event is similar to the tendency of occurrence of the other event is distinguishable from a relationship line indicating that the tendency of occurrence of one event is opposite to the tendency of occurrence of the other event.

With respect to a relationship line connecting events to each other, the relationship setting module 2840 may also determine that a change in one of two events connected by the relationship line is related to a change in the other event or that there is no specifiable relationship between such changes.

In such a case, the relationship diagram display module 2845 may also display a relationship line according to the setting by the relationship setting module 2840 in such a way that a relationship line indicating that a change in one event is related to a change in the other event is distinguishable from a relationship line indicating that there is no specifiable relationship between such changes.

When converting a relationship diagram into a deployment table, the deployment table generation module 2815 may generate the deployment table such that a change in an event shown in the deployment table tends to increase.

The deployment table generation module 2815 may correct a relationship diagram such that a causal relationship is maintained and a change in an event shown in a deployment table tends to increase, and then convert the relationship diagram into the deployment table.

When converting a deployment table into a relationship diagram, the relationship diagram generation module 2830 may generate the relationship diagram in accordance with a relationship between events in the relationship diagram.

When a deployment table is converted into a relationship diagram, in some cases, there is an original relationship diagram. For example, the deployment table may be one converted from a relationship diagram. In such a case, a correction is then performed on the deployment table, and the correction is reflected in the original relationship diagram.

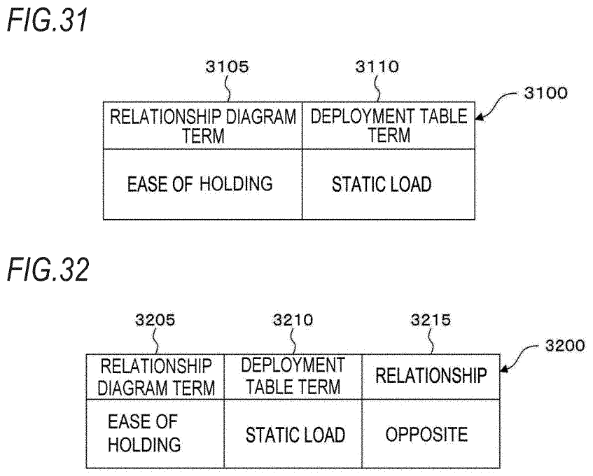

The relationship diagram generation module 2830 includes a storage unit (corresponding to a relationship diagram term deployment table term correspondence table 3100 illustrated in the example of FIG. 31 to be described below) that stores a first term used in a relationship diagram and a second term used in a deployment table in association with each other. When converting a relationship diagram into a deployment table or a deployment table into a relationship diagram, the relationship diagram generation module 2830 may convert a first term or a second term into a second term or a first term by using the storage unit. As a “term,” there is mainly an event name. Otherwise, a term used in the comment (annotation) may be included. For example, as a first term, there is a “temperature of a food ingredient at the time of heating” (an event name used in a relationship diagram), and as a corresponding second term, there is a “food ingredient temperature” (an event name used in a deployment table).

Information indicating that a first term and a second term are opposite in the increase or decrease may be set in the storage unit in the relationship diagram generation module 2830.

Then, when information indicating that first and second terms are opposite in increase or decrease is set in the storage unit, the relationship diagram generation module 2830 may perform conversion into a deployment table or a relationship diagram in such a way that an event occurrence tendency in the deployment table or relationship diagram as a conversion destination is inversely related to that in the relationship diagram or deployment table as a conversion source. Specifically, the conversion is performed in such a way that the event occurrence tendency in the deployment table as a conversion destination is inversely related to that in the relationship diagram, or the conversion is performed in such a way that the event occurrence tendency in the relationship diagram as a conversion destination is inversely related to that in the deployment table.

For example, when the term “softness of board” is used in the relationship diagram and the term “rigidity” is used in the deployment table, information indicating, with respect to the correspondence between the two terms, that “an increase or decrease in one is opposite to an increase or decrease in the other” is set in a storage unit (corresponding to a relationship field 3215 of a relationship diagram term deployment table term correspondence table 3200 illustrated in the example of FIG. 32 to be described below). Then, when a relationship diagram is converted into a deployment table, a relationship opposite to the relationship between the tendencies of occurrence of events on the relationship line in the relationship diagram is set in the deployment table. On the other hand, when a deployment table is converted into a relationship diagram, a relationship opposite to the relationship between the tendencies of occurrence of events in the deployment table is expressed by a relationship line in the relationship diagram.

In a relationship diagram displayed by the relationship diagram display module 2845, even for an indirectly related event, it is possible to anticipate a phenomenon by visualizing the occurrence tendency relationship. It is possible to visualize a mechanism of an occurrence of a secondary failure, such as a case where the change of a factor for improving a certain result adversely affects another result

The event may also include an event not expressible by an amount such as “ingredient selection.” The increase/decrease relationship between events may not be clear.

In a relationship diagram displayed by the relationship diagram display module 2845, it becomes possible to anticipate a phenomenon by visualizing an increase/decrease relationship, regarding such events or relationships between events. It is possible to visualize a mechanism of an occurrence of a secondary failure such as a case where the change of a factor for improving a certain result adversely affects another result, regarding such events or relationships between events.

By the deployment table generation module 2815 and the relationship diagram generation module 2830, a relationship diagram and a deployment table in which an increase/decrease relationship is described may be converted into each other.

By the relationship diagram generation module 2830 and the storage unit in the relationship diagram generation module 2830, a relationship diagram may be converted into a deployment table even when regarding a certain event, a term described in the relationship diagram and a term described in the deployment table are different from each other. Even when these are opposite in the increase/decrease relationship, the relationship diagram may be converted into the deployment table.

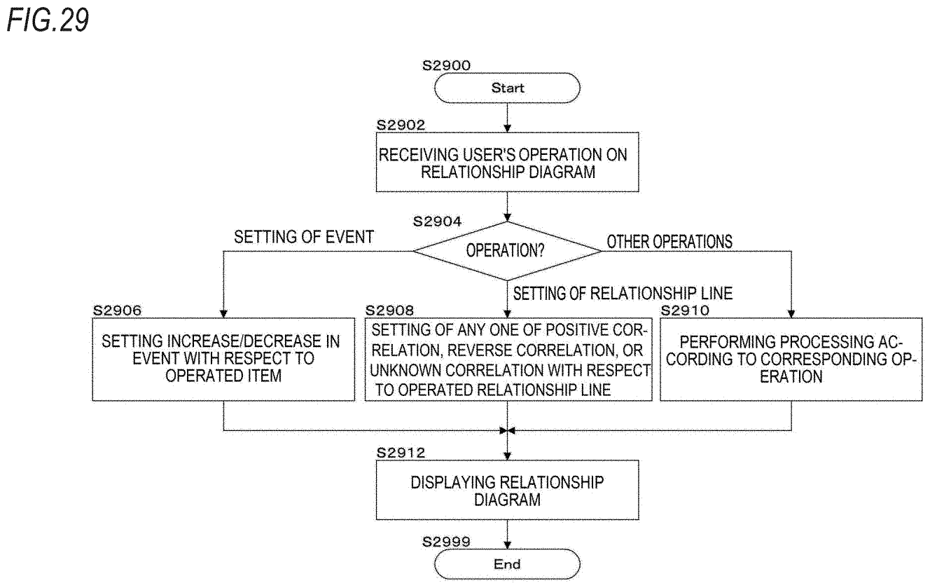

FIG. 29 is a flowchart illustrating an example of a processing according to the second exemplary embodiment.

In step S2902, the relationship diagram operation receiving module 2825 receives user's operation on a relationship diagram.

In step S2904, the relationship diagram generation module 2830 determines the received operation. When it is determined that the operation is “setting of event,” the process proceeds to step S2906, when it is determined that the operation is “setting of relationship line,” the process proceeds to step S2908, and when it is determined that the operation is “another operation,” the process proceeds to step S2910.

In step S2906, the event setting module 2835 sets increase/decrease of an event with respect to the operated item.

In step S2908, the relationship setting module 2840 sets, any one of a positive correlation, an inverse correlation, and an unknown correlation with respect to the operated relationship line. Here, the positive correlation is setting indicating that the tendencies of occurrence of events connected by the relationship line are similar to each other, and the inverse correlation is setting indicating that the tendencies of occurrence of events connected by the relationship line are opposite to each other.

In step S2910, the relationship diagram generation module 2830 performs a processing according to the corresponding operation.

In step S2912, the relationship diagram display module 2845 displays a relationship diagram.

In step S2906, specifically, in the increase decrease field 1040 of the item information table 1000, either increase or decrease may be set.

In step S2908, specifically, in the relevance field 1125 of the relationship line information table 1100, any one of a positive correlation, an inverse correlation, and an unknown correlation (a relationship is unknown) may be set.

In step S2908, any one among three relationships (positive correlation, inverse correlation, and unknown correlation) is set, but the followings may be performed. (1) After either correlated or unknown correlation is set, in a case of correlated, positive correlation or inverse correlation may be further set. In this case, two-step operation may be performed. (2) When setting either a positive correlation or an inverse correlation is set as a default operation, in a case where there is an operation with respect to a case where there is an unknown correlation, an operation of setting any one among three relationships (positive correlation, inverse correlation, unknown correlation) may be allowed.

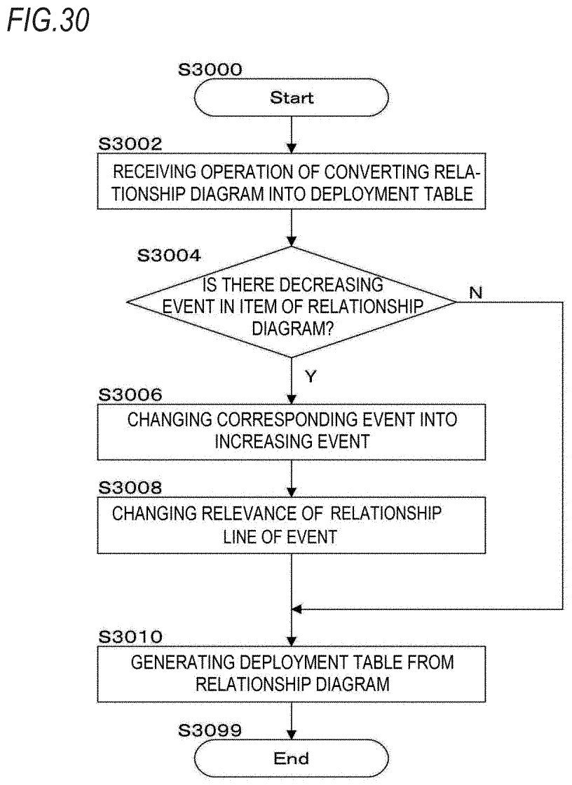

FIG. 30 is a flowchart illustrating an example of a processing according to the second exemplary embodiment.

In step S3002, the relationship diagram operation receiving module 2825 receives an operation of converting a relationship diagram into a deployment table.

In step S3004, it is determined whether there is a decreasing event in an item of a relationship diagram. When it is determined that there is a decreasing event, the process proceeds to step S3006. Otherwise, the process proceeds to step S3010.

In step S3006, the event is changed into an increasing event.

In step S3008, a relevance of a relationship line of the event is changed.

In step S3010, a deployment table is generated from the relationship diagram.

According to a change from a decreasing event to an increasing event, the relevance of a relationship line may be inverted. That is, a positive correlation may be changed into an inverse correlation, and an inverse correlation may be changed into a positive correlation.

When a relevance is unknown, the relevance may remain in an unknown state (not changed). In items at both ends of a relationship line, when an event is changed into an increasing event, a relevance may not be changed. In such a case as well, whenever an event is changed into an increasing event, the relevance of a relationship line may be changed.

Unlike this example described above, in which a deployment table is generated after increase/decrease of an event or a relationship line in a relationship diagram is changed, a deployment table may be directly generated from an original relationship diagram, and at that time, the relevance between events may be estimated using, for example, a calculation formula.

The relationship diagram generation module 2830 may include the relationship diagram term deployment table term correspondence table 3100. FIG. 31 is an explanatory view illustrating an example of a data structure of the relationship diagram term deployment table term correspondence table 3100. The relationship diagram term deployment table term correspondence table 3100 includes a relationship diagram term field 3105, and a deployment table term field 3110. The relationship diagram term field 3105 stores a relationship diagram term. The deployment table term field 3110 stores a deployment table term.

For example, it is described that a deployment table term corresponding to a relationship diagram term “ease of holding” is “static load.”

The relationship diagram generation module 2830 may include the relationship diagram term deployment table term correspondence table 3200. FIG. 32 is an explanatory view illustrating an example of a data structure of the relationship diagram term deployment table term correspondence table 3200. The relationship diagram term deployment table term correspondence table 3200 includes a relationship diagram term field 3205, a deployment table term field 3210, and the relationship field 3215. The relationship diagram term field 3205 stores a relationship diagram term. The deployment table term field 3210 stores a deployment table term. The relationship field 3215 stores a relationship.

For example, it is indicated that the relationship diagram term “ease of holding” corresponds to the deployment table term “static load” and they have an “opposite” relationship.

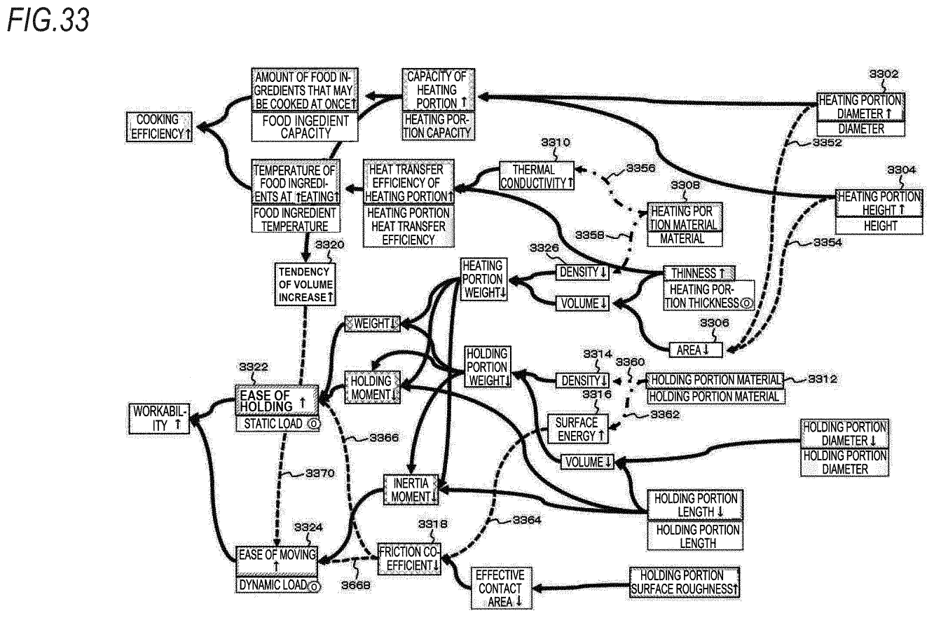

FIG. 33 is an explanatory view illustrating an example of a relationship diagram. This illustrates an example of a relationship diagram in which of a relationship between occurrence tendencies of events is set. The solid relationship lines indicate that the tendency of occurrence of one event is similar to the tendency of occurrence of another event. The dotted relationship lines indicate an opposite relationship. This relationship means that when one event occurs, an event opposite to the other event occurs. The one dot chain relationship lines indicate that there is no specifiable relationship with respect to increase or decrease.

An inverse correlation relationship line 3352 indicates that a heating portion diameter (↑) 3302 and an area (↓) 3306 are inversely correlated (opposite relationship). This indicates that as the heating portion diameter increases due to the occurrence of the heating portion diameter (↑) 3302, the area of the metal plate used in the heating portion increases due to the occurrence of an event opposite to the area (↓) 3306.

An inverse correlation relationship line 3354 indicates that a heating portion height (↑) 3304 and the area (↓) 3306 are inversely correlated. This indicates that as the heating portion height increases due to the occurrence of the heating portion height (↑) 3304, the area increases due to the occurrence of an event opposite to the area (↓) 3306.

An inverse correlation relationship line 3364 indicates that a surface energy (↑) 3316 and a friction coefficient (↓) 3318 are inversely correlated. This indicates that as the surface energy increases due to the occurrence of the surface energy (↑) 3316, the friction coefficient increases due to the occurrence of an event opposite to the friction coefficient (↓) 3318.

An inverse correlation relationship line 3366 indicates that the friction coefficient (↓) 3318 and ease of holding (↑) 3322 are inversely correlated. This indicates that as the friction coefficient decreases due to the occurrence of the friction coefficient (↓) 3318, the degree of ease of holding decreases due to the occurrence of an event opposite to the ease of holding (↑) 3322.

An inverse correlation relationship line 3368 indicates that the friction coefficient (↓) 3318 and ease of moving (↑) 3324 are inversely correlated. This indicates that as the friction coefficient decreases due to the occurrence of the friction coefficient (↓) 3318, the degree of ease of moving decreases due to the occurrence of an event opposite to the ease of moving (↑) 3324.

An inverse correlation relationship line 3370 indicates that tendency of volume increase (↑) 3320, and ease of moving (↑) 3324 are inversely correlated. This indicates that as the tendency of volume increase increases due to the occurrence of the tendency of volume increase (↑) 3320, the degree of ease of moving decreases due to the occurrence of an event opposite to the ease of moving (↑) 3324.

An unknown correlation relationship line 3356 indicates that a heating portion material 3308 is related to a thermal conductivity (↑) 3310, but it is unknown whether a correlation is positive or inversed (a relationship between event occurrence tendencies is not specifiable).

An unknown correlation relationship line 3358 indicates that the heating portion material 3308 is related to a density (↓) 3326, but it is unknown whether a correlation is positive or inversed.

An unknown correlation relationship line 3360 indicates that a holding portion material 3312 is related to a density (↓) 3314, but it is unknown whether a correlation is positive or inversed.

An unknown correlation relationship line 3362 indicates that the holding portion material 3312 is related to the surface energy (↑) 3316, but it is unknown whether a correlation is positive or inversed.

In the relationship diagram illustrated in the example of FIG. 33, in a case where an item has two stages, the upper side indicates a term in a relationship diagram, and the lower side indicates a term in a deployment table. For this, the relationship diagram term deployment table term correspondence table 3100 illustrated in the example of FIG. 31 may be used.

At the lower side, “o” surrounded by a circle (“o” represents “opposite”) indicates that the term in the relationship diagram is used in a way opposite to the term in the deployment table.

For example, “ease of holding” as a term in the relationship diagram corresponds to “static load” as a term in the deployment table, and the “o” surrounded by the circle drawn in the relationship diagram indicates that an increase in the degree of “ease of holding” corresponds to a decrease in “static load.”

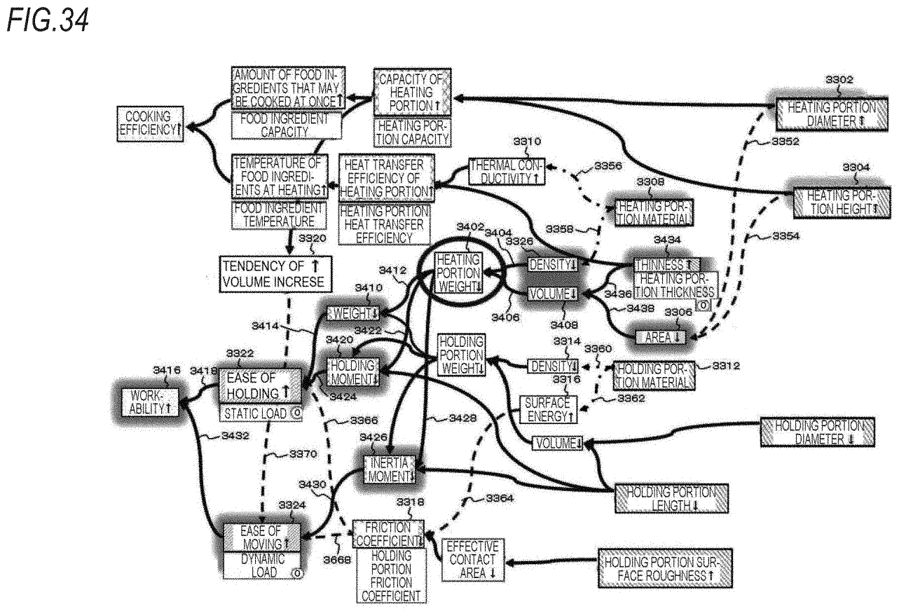

FIG. 34 is an explanatory view illustrating an example of a relationship diagram. This illustrates an example of a relationship diagram in which a relationship between occurrence tendencies of events is visualized.

For example, it is described that when an event of a “heating portion weight (↓) 3402” is selected, by user's operation, relationships with other events in occurrence tendencies are displayed as a result. When the event of the “heating portion weight (↑) 3402” decreases, an event shining in blue indicates that what is written in the event occurs, an event shining in red indicates that one opposite to what is written in the event occurs, and an event shining in grey indicates that the event occurs, but it is unknown whether what is written in the event or one opposite thereto occurs. Here, “what is written in an event occurs” includes both the occurrence of an event as a result of occurrence of the “heating portion weight (↓) 3402” and that the occurrence of the event as a cause of the “healing portion weight (↓) 3402.” The “one opposite to what is written in an event occurs” includes both the occurrence of one opposite to the event as a result of occurrence of the “heating portion weight (↓) 3402” and the occurrence of one opposite to the event as a cause of the “heating portion weight (↓) 3402.”

The “density (↓) 3326” connected to the “heating portion weight (↓) 3402” by a relationship line 3404 shines in blue, and “the heating portion material 3308 connected to “the “density (↓) 3326” by the unknown correlation relationship line 3358 shines in grey.

A “volume (↓) 3408” connected to the “heating portion weight (↓) 3402” by a relationship line 3406 shines in blue, and a “thinness (↑) 3434” connected to the “volume (↓) 3408” by a relationship line 3436 shines in blue.

The “volume (↓) 3408” connected to the “heating portion weight (↓) 3402” by the relationship line 3406 shines in blue, the “area (↓) 3306” connected to the “volume (↓) 3408” by a relationship line 3438 shines in blue, and the “heating portion diameter (↑) 3302” connected to the “area (↓) 3306” by the inverse correlation relationship line 3352 shines in red.

The “volume (↓) 3408” connected to the “heating portion weight (↓) 3402” by the relationship line 3406 shines in blue, the “area (↓) 3306” connected to the “volume (↓) 3408 by the relationship line 3438 shines in blue, and the “heating portion height (↑) 3304” connected to the “area (↓) 3306” by the inverse correlation relationship line 3354 shines in red.

A “weight (↓) 3410” connected to the “heating portion weight(↓) 3402” by a relationship line 3412 shines in blue, the “ease of holding (↑) 3322” connected to the “weight (↓) 3410” by a relationship line 3414 shines in blue, and a “workability (↑) 3416” connected to the “ease of holding (↑) 3322” by a relationship line 3418 shines in blue.

A “retention moment (↓) 3420” connected to the “heating portion weight (↓) 3402” by a relationship line 3422 shines in blue, the “ease of holding (↑) 3322” connected to the “retention moment (↓) 3420” by a relationship line 3424 shines in blue, and the “workability (↑) 3416” connected to the “ease of holding (↑) 3322” by the relationship line 3418 shines in blue.

An “inertia moment (↓) 3426” connected to the “heating portion weight (↓) 3402” by a relationship line 3428 shines in blue, the “ease of moving (↑) 3324” connected to the “inertia moment (↓) 3426” by a relationship line 3430 shines in blue, and the “workability (↑) 3416” connected to the “ease of moving (↑) 3324” by a relationship line 3432 shines in blue.

In the case of shining in blue, shining in red, or shining in grey, the background may be colored in the corresponding color, may blink in the corresponding color, or another form may be represented differently (a rectangle surrounding an event may be represented in different forms such as a general rectangle, a double-frame rectangle, and an edge-rounded rectangle).

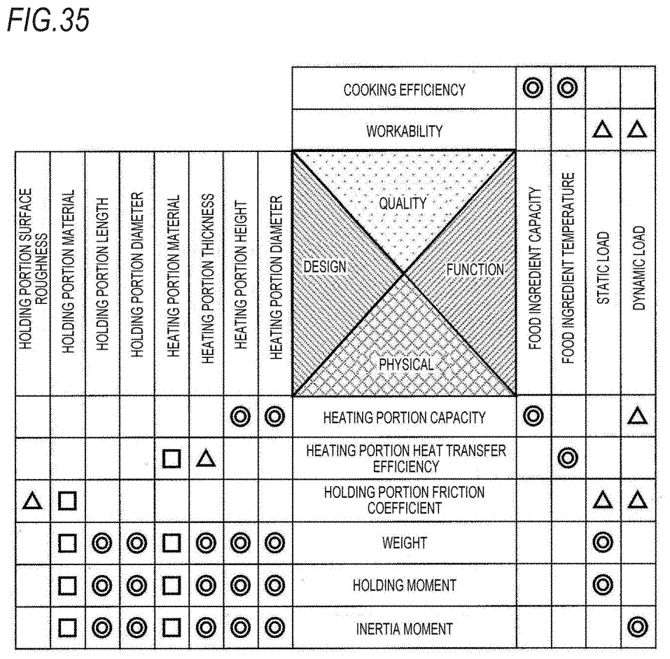

FIG. 35 is an explanatory view illustrating an example of a deployment table. This illustrates an example in which the relationship diagram illustrated in the example of FIG. 33 (or FIG. 34) is converted into a four-axis deployment table.

The double circle mark in a matrix cell indicates that the tendency of occurrence of one event is similar to the tendency of occurrence of the other event. The triangular mark indicates that the tendency of occurrence of one event is opposite to the tendency of occurrence of the other event. The square mark indicates that two events are related but there is no specifiable relationship between occurrence tendencies (two events are related but not expresses by the double circle mark or the triangular mark).

For example, from the relationship diagram illustrated in the example of FIG. 34, it is found that when a friction coefficient decreases due to the occurrence of the event “friction coefficient (↓) 3318,” holding is not easy due to the occurrence of an event opposite to the “ease of holding (↑) 3322.” The item of the “friction coefficient (↓) 3318” has two stages, and a “holding portion friction coefficient” is defined as a term used in a deployment table. That is, when the “friction coefficient” decreases, the “holding portion friction coefficient” also decreases. The item of the “ease of holding (↑) 3322” has two stages, and a “static load” is defined as a term used in a deployment table. In addition, the “o” surrounded by the circle drawn for the “static load” indicates that as the degree of “ease of holding” increases, the “static load” decreases. Accordingly, as the “holding portion friction coefficient” decreases, the degree of “ease of holding” decreases, and as a result, the “static load” increases. According to this, in the deployment table illustrated in the example of FIG. 35, a symbol indicating a relationship is described at the intersection between the “holding portion friction coefficient” and the “static load.” In the deployment table, in general, it is thought that items described on axes are increasing events. Thus, it is thought that when the “holding portion friction coefficient” increases, the “static load” increases. However, here, when the “holding portion friction coefficient” increases, the “static load” decreases. Thus, the tendencies of occurrence of events are opposite to each other, and then the symbol “Δ” is drawn.

For example, from the relationship diagram illustrated in the example of FIG. 34, it is found that the “friction coefficient (↓) 3318” is affected by the “surface energy (↑) 3316,” and the “surface energy (↑) 3316” is affected by “the holding portion material 3312.” The item of the “friction coefficient (↓) 3318” has two stages, and the “holding portion friction coefficient” is defined as a term used in a deployment table. Thus, in the deployment table illustrated in the example of FIG. 35, a symbol is described at the intersection between the “holding portion material” and the “holding portion friction coefficient.” From the relationship diagram illustrated in the example of FIG. 34, it is found that when the “surface energy (↑) 3316” occurs, an event opposite to the “friction coefficient (↓) 3318” occurs. However, a relationship between occurrence tendencies of “the holding portion material 3312” and the “surface energy (↑) 3316” is not known. Thus, a relationship between occurrence tendencies of the “holding portion material” and the “holding portion friction coefficient” is also not known. Thus, in the deployment table illustrated in the example of FIG. 35, a square mark indicating that the relationship between occurrence tendencies is not known is drawn at the intersection between the “holding portion material” and the “holding portion friction coefficient.”

This mark may be distinguishable by another form, for example, a color. The double circle mark may be replaced by a blue circle, the triangular mark may be replaced by a red circle, and the square mark may be replaced by a black circle.

The examples illustrated in FIGS. 34, 35, and 36 mainly show examples of the display of relationship lines and marks in cells.

### Third Exemplary Embodiment

The third exemplary embodiment has a background on a deployment table and a relationship diagram similarly to the second exemplary embodiment.

The relationship diagram is suitable for describing results and factors thereof in detail without omission/redundancy. Meanwhile, when the number of events as targets excessively increases, the diagram becomes excessively complicated, and becomes hypertrophic. This causes difficulty in a practical use. Meanwhile, in the deployment table, among many events, important things are extracted and arranged on axes, and then causal relationships are expressed in a matrix. Thus, relationships between many results and many factors may be simply expressed. However, it is not possible to express detailed causal relationships involving events not arranged on the axes. As a result, missing of items is likely to occur.

The relationship diagram and the multiaxial deployment table may be used in combination so that it is possible to extract and describe causal relationships in detail without omission/redundancy, and to briefly display relationships between a large number of factors and results. However, conversion between the relationship diagram and the multiaxial deployment table is complicated, and thus for such a purpose, a system supporting the conversion becomes necessary.

There is already a system that draws a relationship diagram in which causal relationships are hierarchized, and selects hierarchies so as to display a biaxial deployment table. However, in order to create a relationship diagram in a hierarchized state, it is necessary that causal relationships are hierarchically organized from the beginning. Thus, it is difficult to perform detailed development of causal relationships without omission/redundancy, which is an original purpose. Even in a case where factors are divided into hierarchies, if all factors of selected hierarchies are displayed on a deployment table, an amount of information pieces to be displayed increases, and thus it is not possible to achieve the purpose of “extracting important factors” and displaying the factors.

In order to address such a problem, in JP-A-2016-081185, there is proposed a technique in which in a created relationship diagram, events corresponding to respective axes of a deployment table are selected and then deployed on the deployment table.

When the relationship diagram is created, it is desirable that the relationship diagram is freely created without restrictions on ideas and finally causal relationships are drawn without inconsistency. Meanwhile, when the relationship diagram is freely drawn, a causal relationship not expressible in the deployment table may occur. When the causal relationship is wrong, correction is necessary. In some cases, however, such an error is not recognizable, which makes correction impossible. Even when an error is recognized, in an enlarged relationship diagram or deployment table, it is difficult to specify which relationship needs to be corrected. In some cases, such a state should be maintained because there is no inconsistency in the causal relationships although it is not possible to perform conversion into a deployment table.

Therefore, in the third exemplary embodiment, when a causal relationship not expressible in a deployment table is found in reflecting the edition of the relationship diagram in the deployment table, the causal relationship line on the relationship diagram, the event on the deployment table connected with the relationship line, or both of them are displayed distinguishably from other relationship lines or events.

This informs a user that there is a possibility that an inconsistent causal relationship is present, thereby demanding correction and supporting an efficient correction work. A relationship line or an event itself may not be distinguishable from others, but it is possible to use, for example, a method of displaying a list in which each is specifiable.

A relationship line on a relationship diagram, or an event on a deployment table, which is displayed in a manner distinguishable from others, may become not distinguishable from others through user's operation.

This may correspond to a case where although it is not possible to perform conversion into a deployment table, since there is no inconsistency in a causal relationship, the current state may be maintained.

When a correspondence between an event in a relationship diagram and an axis of a deployment table is set and a causal relationship is converted into the deployment table, in a case where a causal relationship in a direction opposite to a cause-effect direction in the deployment table occurs, the causal relationship is described in the deployment table.

In a case of a causal relationship in a direction opposite to a cause-effect direction in a deployment table, for example, in a deployment table having a function as a vertical axis, and a quality as a horizontal axis, the function on the vertical axis is a factor and the quality on the horizontal axis is a result thereof. For a heater, when “heating” as the function on the vertical axis is expressed, as a result, “rising temperature” as the quality on the horizontal axis may be obtained. Accordingly, a causal relationship in a corresponding relationship diagram is always indicated by an arrow directed from an event set as an item on the vertical axis, toward an event set as an item on the horizontal axis. Here, when an arrow of a causal relationship is drawn from an event set as an item on the horizontal axis toward an event set as an item on the vertical axis, since the causal relationship becomes inconsistent, the relationship is generally not displayed on a deployment table. However, for example, as in a case where a temperature rises by a heater, and as a result, evaporation of water on a dish is progressing, another function may be expressed. Such a case may be dealt with by measures in which when there is a causal relationship in an opposite direction, displaying on a deployment table is made after confirmation by a user.

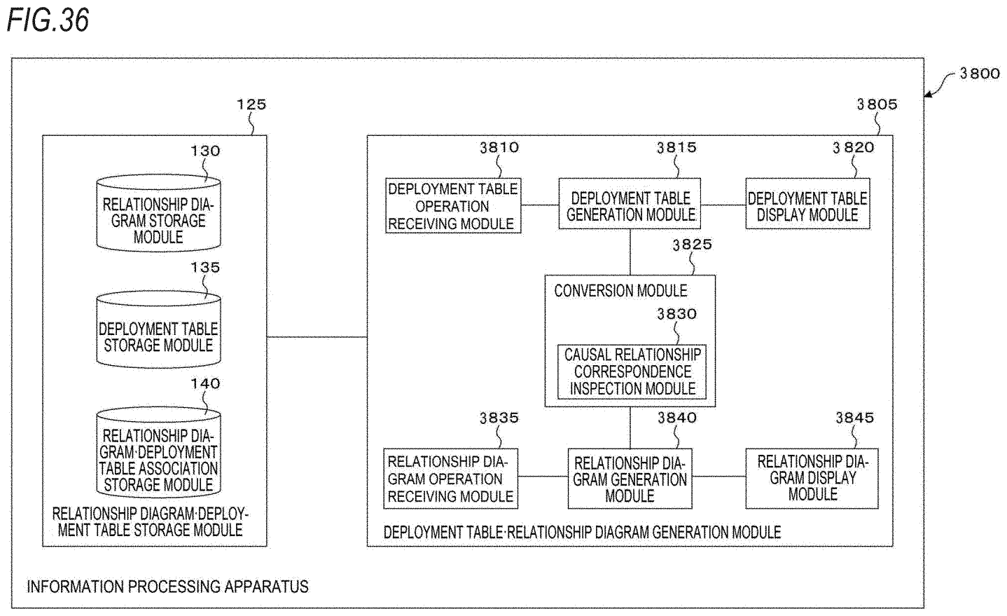

FIG. 36 is a schematic module diagram illustrating an example of a configuration according to the third exemplary embodiment.

The same portions as those of the first exemplary embodiment are denoted by the same reference numerals and redundant explanations thereof will be omitted. The first exemplary embodiment and the third exemplary embodiment may be combined with each other.

The “correction” includes change and deletion of original information, and addition of new information.

An “element” is an element constituting a relationship diagram,corresponds to an event (also referred to as a box), and a relationship line (also referred to as a connection line) as described above, and corresponds to a node (node, vertex) and an edge (branch, side, connector) in a graph theory. For example, when an item on an axis in a deployment table is corrected, an event in a relationship diagram corresponding to the corrected item is corrected, and then the corrected event is converted into a form different from that of the uncorrected event. When a symbol or a numerical value arranged in a matrix of a deployment table is corrected, a relationship line in a relationship diagram corresponding to the corrected symbol or the corrected numerical value is corrected, and then the corrected relationship line is converted into a form different from that of the uncorrected relationship line.

A display module (a deployment table display module 3820, a relationship diagram display module 3845) may take any of forms (1) a display module that includes a display device, and causes the display device to display a target (a relationship diagram, a deployment table), and (2) a display control module that performs a control to display a target on a display device (a control module not including the display device itself).

An information processing device 3800 includes a relationship diagram deployment table storage module 125, and a deployment table relationship diagram generation module 3805.

The relationship diagram deployment table storage module 125 includes a relationship diagram storage module 130, a deployment table storage module 135, and a relationship diagram deployment table association storage module 140, and is connected to the deployment table relationship diagram generation module 3805.

The deployment table relationship diagram generation module 3805 includes a deployment table operation receiving module 3810, a deployment table generation module 3815, the deployment table display module 3820, a conversion module 3825, a relationship diagram operation receiving module 3835, a relationship diagram generation module 3840, and the relationship diagram display module 3845, and is connected to the relationship diagram deployment table storage module 125. The deployment table relationship diagram generation module 3805 performs a processing related to generation of a deployment table or a relationship diagram (which may include correction).

The deployment table operation receiving module 3810, the deployment table generation module 3815, and the deployment table display module 3820 perform a processing (e.g., creation, correction, or displaying) on a deployment table in which relationships between items listed on plural (particularly, three or more) axes perpendicular to each other are indicated by symbols or numerical values arranged in a matrix.

The relationship diagram operation receiving module 3835, the relationship diagram generation module 3840, and the relationship diagram display module 3845 perform a processing (e.g., creation, correction, or displaying) on a relationship diagram (a tree diagram is typical) in which relationship lines connect events to each other so as to express relationships.

The conversion module 3825 selects an event in a relationship diagram corresponding to an axis of a deployment table so as to give a correspondence relationship to the two, and perform a processing such as mutual conversion. In the mutual conversion processing, the above described technique described in, for example, JP-A-2016-081185 may be used. Techniques other than the technique described in, for example, JP-A-2016-081185 will be mainly described below.

The deployment table operation receiving module 3810 is connected to the deployment table generation module 3815. The deployment table operation receiving module 3810 receives user's operation on a deployment table displayed by the deployment table display module 3820.

The deployment table generation module 3815 is connected to the deployment table operation receiving module 3810, the deployment table display module 3820, and the conversion module 3825. The deployment table generation module 3815 generates a deployment table according to an operation received by the deployment table operation receiving module 3810.

The deployment table display module 3820 is connected to the deployment table generation module 3815. The deployment table display module 3820 displays the deployment table generated by the deployment table generation module 3815 on a display device such as a liquid crystal display.

Then, when there is a causal relationship not expressible in a deployment table among causal relationships between events in a relationship diagram, the deployment table display module 3820 performs, on the deployment table, a display indicating that the relationship diagram has a causal relationship not expressible in the deployment table. Here, “a causal relationship between events in a relationship diagram” refers to a causal relationship indicated by a relationship line connecting the events to each other in the relationship diagram. Specifically, when a relationship line is indicated by an arrow, an event at an origin of the arrow indicates a causal event, and an event at a destination of the arrow indicates a resultant event.

For example, “the display indicating that the relationship diagram has a causal relationship not expressible in the deployment table” may be the display of a message indicating such a fact or may be such that the corresponding relationship lines or events are displayed distinguishably from others as described below.

When the conversion module 3825 converts a relationship diagram into a deployment table and when a causal relationship correspondence inspection module 3830 finds that there is a causal relationship not expressible in the deployment table, the deployment table display module 3820 may perform, on the deployment table, a display indicating that the relationship diagram has a causal relationship not expressible in the deployment table.

When events in a relationship diagram correspond to axes in a deployment table and when the relationship diagram has a causal relationship occurring in a direction opposite to a cause-effect direction in the deployment table, the deployment table display module 3820 may perform, on the deployment table, a display indicating that there is a causal relationship in a direction opposite to a cause-effect direction in the deployment table.

The deployment table display module 3820 may also perform a display indicating, in a cell showing a combination of events in the deployment table, that the direction of the causal relationship is opposite.

The conversion module 3825 includes the causal relationship correspondence inspection module 3830, and is connected to the deployment table generation module 3815, and the relationship diagram generation module 3840. The conversion module 3825 converts a relationship diagram into a deployment table or converts a deployment table into a relationship diagram.

When a relationship diagram is corrected, the conversion module 3825 may correct a deployment table corresponding to the relationship diagram. Inversely, when a deployment table is corrected, the conversion module 3825 may correct a relationship diagram corresponding to the deployment table. Then, the deployment table display module 3820 and the relationship diagram display module 3845 may display corrected elements in a form different from that of uncorrected elements.

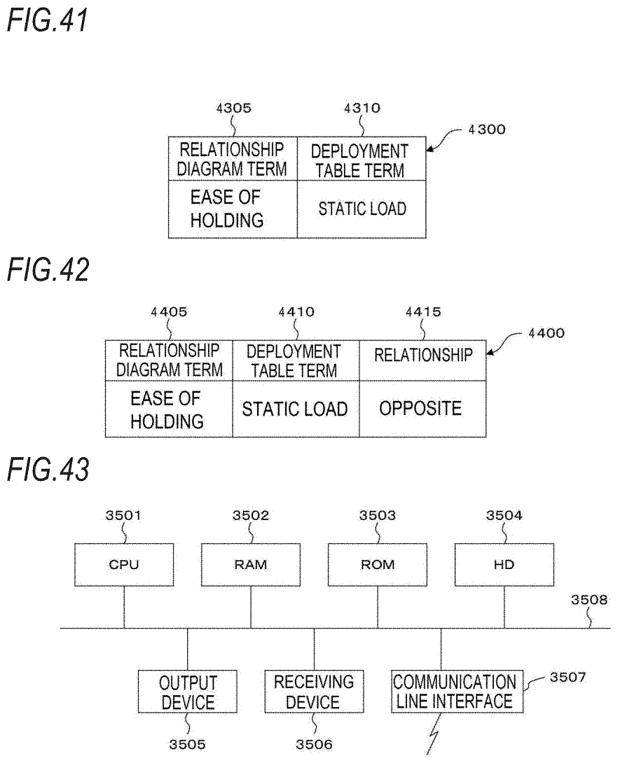

The conversion module 3825 includes a storage unit (corresponding to a relationship diagram term deployment table term correspondence table 4300 illustrated in the example of FIG. 41 to be described below) that stores a first term used in a relationship diagram and a second term used in a deployment table in association with each other. When converting a relationship diagram into a deployment table or a deployment table into a relationship diagram, the conversion module 3825 may convert a first term or a second term into a second term or a first term by using the storage unit. As a “term,” there is mainly an event name. Otherwise, a term used in the comment (annotation) may be included. For example, as a first term, there is a “temperature of a food ingredient at the time of heating” (an event name used in a relationship diagram), and as a corresponding second term, there is a “food ingredient temperature” (an event name used in a deployment table).

Information indicating that a first term and a second term are opposite in the increase or decrease may be set in the storage unit in the conversion module 3825.

Then, when information indicating that a first term and a second term are opposite in the increase or decrease is set in the storage unit, the conversion module 3825 may perform conversion into a deployment table or a relationship diagram as a conversion destination such that an increase/decrease is inversely related to that in a relationship diagram or a deployment table as a conversion source. Specifically, converting into a deployment table as a conversion destination is made such that an increase/decrease is inversely related to that in a relationship diagram, or converting into a relationship diagram as a conversion destination is made such that an increase/decrease is inversely related to that in a deployment table.

For example, when the term “softness of board” is used in the relationship diagram and the term “rigidity” is used in the deployment table, information indicating, with respect to the correspondence between the two terms, that “an increase or decrease in one is opposite to an increase or decrease in the other” is set in a storage unit (corresponding to a relationship field 4415 of a relationship diagram term deployment table term correspondence table 4400 illustrated in the example FIG. 42 to be described below). Then, when a relationship diagram is converted into a deployment table, a relationship opposite to the increase/decrease relationship with respect to a relationship line in the relationship diagram is set in the deployment table. Inversely, when a deployment table is converted into a relationship diagram, a relationship opposite to the increase/decrease relationship in the deployment table is expressed by a relationship line in the relationship diagram.

The causal relationship correspondence inspection module 3830 performs an inspection as to whether causal relationships between events in a relationship diagram agree with those in a deployment table. Specifically, the causal relationship correspondence inspection module 3830 inspects whether there is a causal relationship not expressible in a deployment table, among causal relationships between events in a relationship diagram. In this case, the “causal relationship not expressible in the deployment table” may include a case where events on the same axis in the deployment table are connected by a relationship line, or a case where events present on non-adjacent axes in the deployment table are connected by a relationship line.

The relationship diagram operation receiving module 3835 is connected to the relationship diagram generation module 3840. The relationship diagram operation receiving module 3835 receives user's operation on a relationship diagram displayed by the relationship diagram display module 3845.

The relationship diagram generation module 3840 is connected to the conversion module 3825, the relationship diagram operation receiving module 3835, and the relationship diagram display module 3845. The relationship diagram generation module 3840 generates a relationship diagram according to the operation received by the relationship diagram operation receiving module 3835.

The relationship diagram display module 3845 is connected to the relationship diagram generation module 3840. The relationship diagram display module 3845 displays the relationship diagram generated by the relationship diagram generation module 3840 on a display device such as a liquid crystal display.

Then, when there is a causal relationship not expressible in a deployment table among causal relationships between events in a relationship diagram, the relationship diagram display module 3845 performs, on the relationship diagram, a display indicating that there is a causal relationship not expressible in the deployment table, in the relationship diagram.

When an event of a relationship diagram corresponds to an axis of a deployment table, in a case where a causal relationship in a direction opposite to a cause-effect direction in the deployment table occurs in the relationship diagram, the relationship diagram display module 3845 may perform, on the relationship diagram, a display indicating that there is a causal relationship in a direction opposite to a cause-effect direction in the deployment table.

The deployment table display module 3820 and the relationship diagram display module 3845 may perform any one of displaying a relationship line indicating a causal relationship not expressible in a deployment table, on a relationship diagram in a manner distinguishable from others, displaying events connected by the relationship line, on the deployment table in a manner distinguishable from others, and displaying both the relationship line and the events, on the relationship diagram and the deployment table, in a manner distinguishable from others.

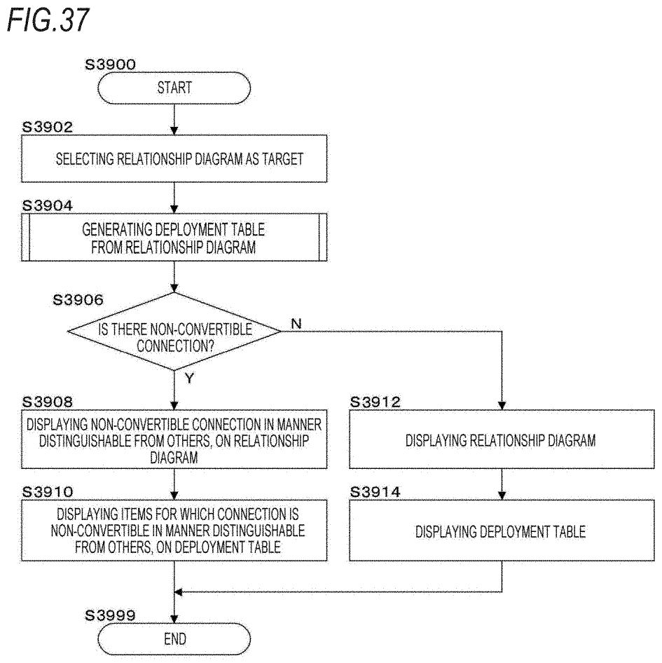

FIG. 37 is a flowchart illustrating an example of a processing according to the third exemplary embodiment.

In step S3902, the relationship diagram operation receiving module 3835 selects a relationship diagram as a target, according to user's operation.

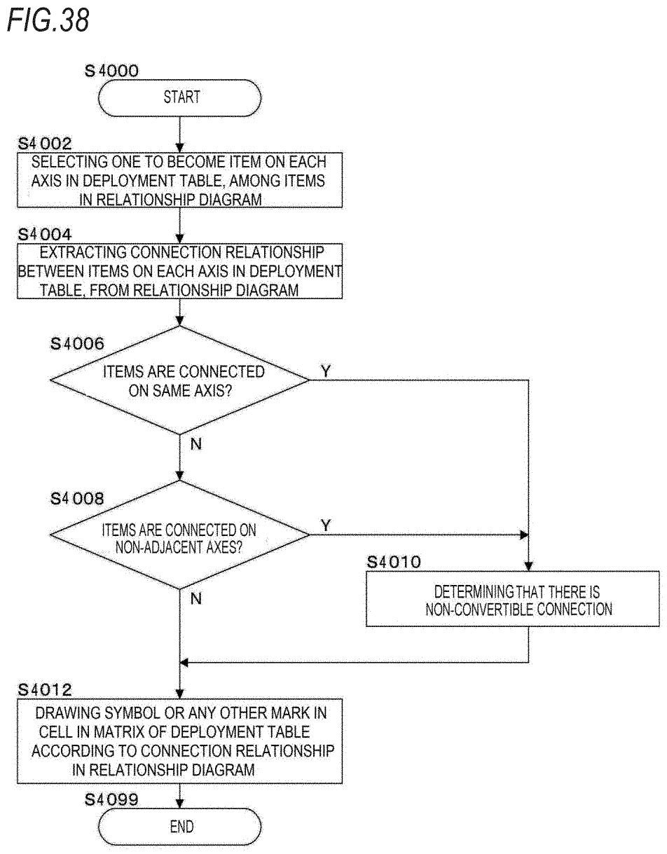

In step S3904, the conversion module 3825 generates a deployment table from the relationship diagram. The detailed processing in step S3904 will be described below with reference to a flowchart illustrated in the example of FIG. 38.

In step S3906, the conversion module 3825 determines whether there is a non-convertible connection as a result of the processing in step S3904. When it is determined that there is a non-convertible connection, the process proceeds to step S3908. Otherwise, the process proceeds to step S3912.

In step S3908, the relationship diagram display module 3845 displays the non-convertible connection in a manner distinguishable from others, on the relationship diagram.

In step S3910, the deployment table display module 3820 displays items for which connection is non-convertible in a manner distinguishable from other, on the deployment table.

In step S3912, the relationship diagram display module 3845 displays the relationship diagram.

In step S3914, the deployment table display module 3820 displays the deployment table.

FIG. 38 is a flowchart illustrating an example of a processing according to the third exemplary embodiment (an example of the processing in step S3904 in the flowchart illustrated in the example of FIG. 37).

In step S4002, the conversion module 3825 selects one to become an item on each axis in the deployment table, among items in the relationship diagram.

In step S4004, the causal relationship correspondence inspection module 3830 extracts a connection relationship between items on respective axes in the deployment table, from the relationship diagram.

In step S4006, the causal relationship correspondence inspection module 3830 determines whether the items are connected on the same axis. When it is determined that the items are connected on the same axis, the process proceeds to step S4010. Otherwise, the process proceeds to step S4008.

In step S4008, the causal relationship correspondence inspection module 3830 determines whether the items are connected on non-adjacent axes. When it is determined that the items are connected on non-adjacent axes, the process proceeds to step S4010. Otherwise, the process proceeds to step S4012.

In step S4010, the causal relationship correspondence inspection module 3830 determines that there is a non-convertible connection.

In step S4012, the conversion module 3825 describes, for example, a symbol in a cell in a matrix of the deployment table, according to the connection relationship in the relationship diagram.

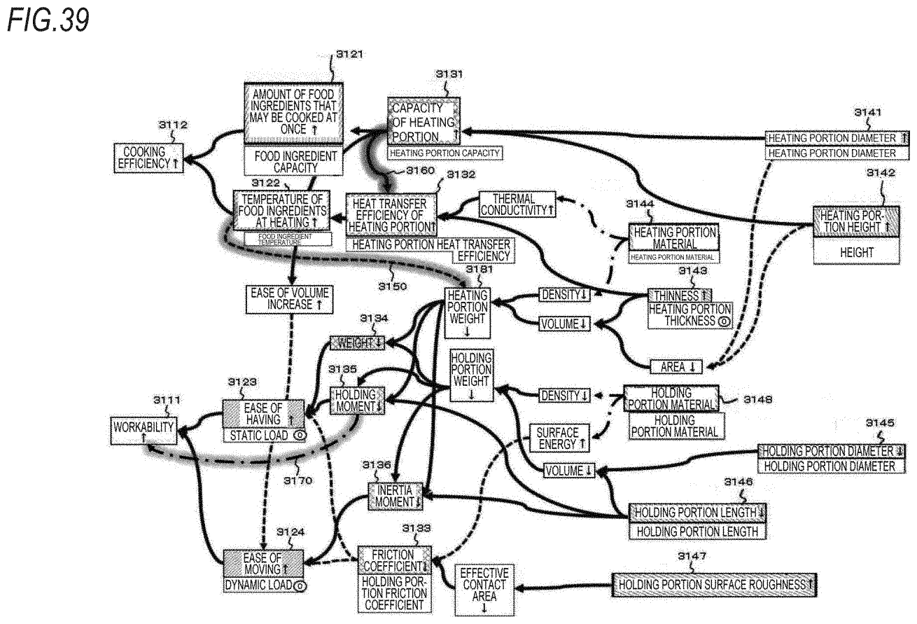

FIG. 39 is an explanatory view illustrating an example of a relationship diagram.

A workability (↑) 3111, and a cooking efficiency (↑) 3112 are selected for a first axis (quality) of a deployment table, an amount of food ingredients that may be cooked at once (↑) 3121, a temperature of food ingredients at the time of heating (↑) 3122, ease of holding (↑) 3123, and ease of moving (↑) 3124 are selected for a second axis (function) of the deployment table, a capacity of heating portion (↑) 3131, a heat transfer efficiency of heating portion (↑) 3132, a friction coefficient (↓) 3133, a weight (↓) 3134, a holding moment (↓) 3135, and an inertia moment (↓) 3136 are selected for a third axis (physical) of the deployment table, and a heating portion diameter (↑) 3141, a heating portion height (↑) 3142, a thinness (↑) 3143, a heating portion material 3144, a holding portion diameter(↓) 3145, a holding portion length (↓) 3146, a holding portion surface roughness (↑) 3147, and a holding portion material 3148 are selected for a fourth axis (design) of the deployment table.

Then, events (the workability (↑) 3111, and the cooking efficiency (↑) 3112) included in the first axis are displayed, for example, in orange. Events (the amount of food ingredients that may be cooked at once (↑) 3121, the temperature of food ingredients at the time of heating (↑) 3122, ease of holding (↑) 3123, and ease of moving (↑) 3124) included in the second axis are displayed, for example, in yellow. Events (the capacity of heating portion (↑) 3131, the heat transfer efficiency of heating portion (↑) 3132, the friction coefficient (↓) 3133, the weight (↓) 3134, the holding moment (↓) 3135, and the inertia moment(↓) 3136) included in the third axis are displayed, for example, in blue. Events (the heating portion diameter (↑) 3141, the heating portion height (↑) 3142, the thinness (↑) 3143, the heating portion material 3144, the holding portion diameter(↓) 3145, the holding portion length (↓) 3146, the holding portion surface roughness (↑) 3147, and the holding portion material 3148) included in the fourth axis are displayed, for example, in green.

The solid relationship lines indicate that the tendency of occurrence of one event is similar to the tendency of occurrence of another event. The dotted relationship lines indicate an opposite relationship. This relationship means that when one event occurs, an event opposite to the other event occurs. The one dot chain relationship lines indicate that there is no specifiable relationship with respect to increase or decrease.

The fact that “the occurrence tendencies are similar to each other” does not always mean that the events similarly increase or decrease. For example, the tendency of occurrence of “an increase in speed” is similar to the tendency of occurrence of “a decrease in time,” because the required time decreases as increasing moving speed to the destination. However, an increase or decrease in “speed” is opposite to an increase or decrease in “time.”

In the example of FIG. 39, a relationship line 3150, a relationship line 3160, and a relationship line 3170 in the relationship diagram correspond to causal relationships not expressible in a deployment table. The relation line 3150 may shine in red, the relation line 3160 in blue, and the relation line 3170 in grey.

In the case of shining in blue, shining in red, or shining in grey, the background may be colored in the corresponding color, may blink in the corresponding color, or another form may be represented differently (a rectangle surrounding an event may be represented in different forms such as a general rectangle, a double-frame rectangle, and an edge-rounded rectangle). That is, the relationship lines of the causal relationships not expressible in the deployment table may be displayed in a manner distinguishable from other relationship lines (relationship lines of causal relationships expressible in the deployment table).

The relationship line 3150 is a relationship line that inversely connects axes to each other in the deployment table. “The temperature of food ingredients at the time of heating (↑) 3122” is connected toward “a healing portion weight (↓) 3181” by the relationship line 3150, and “the heating portion weight (↓) 3181” is connected toward “the weight (↓) 3134,” “the holding moment (↓) 3135,” and “the inertia moment (↓) 3136.” This means that “the temperature of food ingredients at the time of heating (↑) 3122” is a factor, and “the weight (↓) 3134,” “the holding moment (↓) 3135,” and “the inertia moment (↓) 3136” become results thereof. However, on the deployment table, “the weight (↓) 3134,” “the holding moment (↓) 3135,” and “the inertia moment (↓) 3136” are present on the third axis, and “the temperature of food ingredients at the time of heating (↑) 3122” is present on the second axis. Thus, description of symbols indicating causal relationships at the intersections between these on the deployment table means that “the weight (↓) 3134,” “the holding moment (↑) 3135,” and “the inertia moment (↓) 3136” are factors and “the temperature of food ingredients at the time of heating (↑) 3122” becomes a result thereof. Therefore, on the deployment table, it is not possible to display the relationship that “the temperature of food ingredients at the time of heating (↑) 3122” is a factor, and “the weight (↓) 3134,” “the holding moment (↓) 3135,” and “the inertia moment (↓) 3136” become results thereof, as displayed on the relationship diagram. Meanwhile, it is possible to address this case by modifying the mark in a matrix cell, which corresponds to the relationship line, on the deployment table (the mark indicating that there is a causal relationship in a direction opposite to a cause-effect direction in the deployment table).

The relationship line 3160 is a relationship line that connects the same axes to each other in the deployment table. On the deployment table, “the capacity of heating portion (↑) 3131” and “the heat transfer efficiency of heating portion (↑) 3132” are included in the same third axis. However, the relationship line is connected from “the capacity of heating portion (↑) 3131” to “the heat transfer efficiency of heating portion (↑) 3132” on the relationship diagram, but is not expressible on the deployment table.

The relationship line 3170 is a relationship line that connects non-adjacent axes to each other in the deployment table. On deployment table, “the holding moment (↓) 3135” is included in the third axis, and “the workability (↑) 3111” is included in the first axis. However, the relationship line is connected from “the holding moment (↓) 3135” to “the workability (↑) 3111” on the relationship diagram, but is not expressible on the deployment table.

In the relationship diagram illustrated in the example of FIG. 39, in a case where an item has two stages, the upper side indicates a term in a relationship diagram, and the lower side indicates a term in a deployment table. For this, the relationship diagram term deployment table term correspondence table 4300 illustrated in the example of FIG. 41, as described below, may be used.

At the lower side, “o” surrounded by a circle (“o” represents “opposite”) indicates that the term in the relationship diagram is used in a way opposite to the term in the deployment table.

For example, “ease of holding” as a term in the relationship diagram corresponds to “static load” as a term in a deployment table, and the “o” surrounded by the circle drawn in the relationship diagram indicates that an increase in the degree of “ease of holding” corresponds to a decrease in “static load.” For this, the relationship diagram term deployment table term correspondence table 4400 illustrated in the example of FIG. 42, as described below may be used.

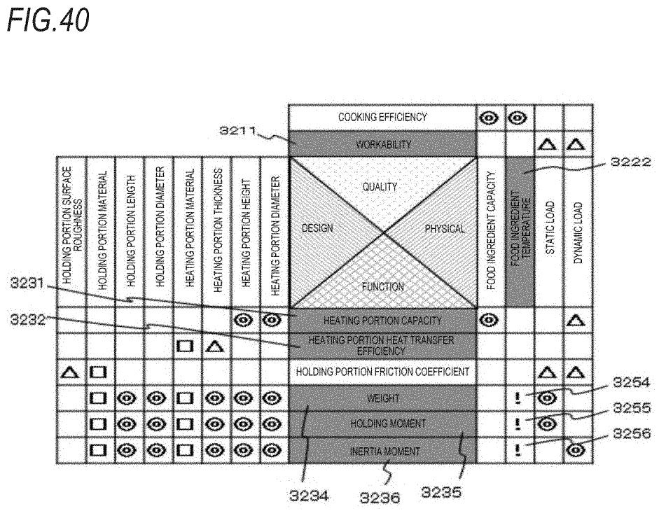

FIG. 40 is an explanatory view illustrating an example of a deployment table. This is a deployment table corresponding to the relationship diagram illustrated in the example of FIG. 39.

From the relationship line 3150 of the relationship diagram illustrated in the example of FIG. 39, the backgrounds of “a food ingredient temperature 3222” corresponding to “the temperature of food ingredients at the time of heating (↑) 3122,” “a weight 3234” corresponding to “the weight (↓) 3134,” “a holding moment 3235” corresponding to “the holding moment (↓) 3135,” and “an inertia moment 3236” corresponding to “the inertia moment (↓) 3136” are colored (in purple).

An inverse connection symbol 3254, an inverse connection symbol 3255, and an inverse connection symbol 3256 indicate that directions of a causal relationship between “the food ingredient temperature 3222” and “the weight 3234,” a causal relationship between “the food ingredient temperature 3222” and “the holding moment 3235,” and a causal relationship between “the food ingredient temperature 3222” and “the inertia moment 3236” are opposite, respectively.

In addition, “the weight (↓) 3134,” “the holding moment (↓) 3135,” and “the inertia moment (↓) 3136” are connected from “the temperature of food ingredients at the time of heating (↑) 3122” via “the heating portion weight (↓) 3181” in an opposite direction.

From the relationship line 3160 of the relationship diagram illustrated in the example of FIG. 39, the backgrounds of “a heating portion capacity 3231” corresponding to “the capacity of heating portion (↑) 3131” and “a heating portion heat transfer efficiency 3232” corresponding to “the heat transfer efficiency of heating portion (↑) 3132” are colored (in purple).

From the relationship line 3170 of the relationship diagram illustrated in the example of FIG. 39, the backgrounds of “the holding moment 3235” corresponding to “the holding moment (↓) 3135” and “a workability 3211” corresponding to “the workability (↑) 3111” are colored (in purple).

That is, when there is a causal relationship that is expressed in a relationship diagram but is not expressible in a deployment table, it is possible to display events (items) connected by a relationship line in a manner distinguishable from other events (events in a case where causal relationships are expressible in the deployment table). When the direction of a relationship line in the relationship diagram is opposite to that in the deployment table, the mark in a cell, which corresponds to the relationship line, may be displayed in a manner distinguishable from marks in other cells (in a case where the direction in the relationship diagram is equal to the direction in the deployment table).

The examples illustrated in FIGS. 39 and 40 mainly show the display of relationship lines on the relationship diagram, the display of items on the deployment table, and the display of marks in cells.

The conversion module 3825 may include the relationship diagram term deployment table term correspondence table 4300. FIG. 41 is an explanatory view, illustrating an example of a data structure of the relationship diagram term deployment table term correspondence table 4300. The relationship diagram term deployment table term correspondence table 4300 includes a relationship diagram term field 4305, and a deployment table term field 4310. The relationship diagram term field 4305 stores a relationship diagram term. The deployment table term field 4310 stores a deployment table term.

For example, it is described that a deployment table term corresponding to a relationship diagram term “ease of holding” is “static load.”

The conversion module 3825 may include the relationship diagram term deployment table term correspondence table 4400. FIG. 42 is an explanatory view illustrating an example of a data structure of the relationship diagram term deployment table term correspondence table 4400. The relationship diagram term deployment table term correspondence table 4400 includes a relationship diagram term field 4405, a deployment table term field 4410, and the relationship field 4415. The relationship diagram term field 4405 stores a relationship diagram term. The deployment table term field 4410 stores a deployment table term. The relationship field 4415 stores a relationship.

For example, it is indicated that the relationship diagram term “ease of holding” corresponds to the deployment table term “static load” and they have an “opposite” relationship.

An example of a hardware configuration of a computer by which a program is executed as the above exemplary embodiment is illustrated in FIG. 43. The hardware includes a general computer, which may be specifically a personal computer or a server. Specifically, a processor (arithmetic unit) includes a CPU 3501, and a storage device includes a RAM 3502, a ROM 3503, and a HD 3504. The HD 3504 may include, for example, a hard disk or a solid state drive (SSD). The hardware includes the CPU 3501 that executes programs such as the relationship diagram deployment table creation module 105, the relationship diagram creation module 110, the deployment table generation module 115, the output module 120, the editing module 145, the deployment table operation receiving module 150, the association information extraction module 155, the display module 160, the relationship diagram editing module 165, the deployment table relationship diagram generation module 2805, the deployment table operation receiving module 2810, the deployment table generation module 2815, the deployment table display module 2820, the relationship diagram operation receiving module 2825, the relationship diagram generation module 2830, the event sating module 2835, the relationship setting module 2840, the relationship diagram display module 2845, the deployment table relationship diagram generation module 3805, the deployment table operation receiving module 3810, the deployment table generation module 3815, the deployment table display module 3820, the conversion module 3825, the causal relationship correspondence inspection module 3830, the relationship diagram operation receiving module 3835, the relationship diagram generation module 3840, and the relationship diagram display module 3845. The hardware includes the RAM 3502 that stores the programs or data, the ROM 3503 that stores, for example, a program used for activating the present computer, the HD 3504 that is an auxiliary storage device (which may be, for example, a flash memory) functioning as, for example, the relationship diagram deployment table storage module 125, the relationship diagram storage module 130, the deployment table storage module 135, or the relationship diagram deployment table association storage module 140, an receiving device 3506 that receives data based on an operation of a user (including, for example, action, voice, and gaze) on, for example, a keyboard, a mouse, a touch screen, a microphone, or a camera (including, for example, a gaze detection camera), an output device 3505 such as a CRT, a liquid crystal display, and a speaker, a communication line interface 3507 used for connection with a communication network, such as a network interface card, and a bus 3508 that connects these to each other in order to exchange data. In the hardware, plural computers may be connected to each other via a network.

In the above described exemplary embodiments, regarding one by a computer program, the computer program as software is read by a system of the present hardware configuration and then the software cooperates with hardware resources so as to implement the above described exemplary embodiments.

The hardware configuration illustrated in FIG. 43 indicates a configuration example, and the exemplary embodiment is not limited to the configuration illustrated in FIG. 43 as long as a configuration where modules described in the exemplary embodiment are executable is employed. For example, some modules may be constituted by dedicated hardware (e.g., an application specific integrated circuit (ASIC)), and some modules may be provided in the external system connected through a communication line. Further, plural systems illustrated in FIG. 43 may be connected to each other through a communication line to cooperate with each other. Especially, the configuration may be incorporated into, for example, a portable information communication device (including a cellular phone, a smart phone, a mobile device, or a wearable computer), information appliances, a robot, a copier, a facsimile, a scanner, a printer, or a multifunction device (an image processing device having any two or more among functions of, for example, a scanner, a printer, a copier, and a facsimile) as well as the personal computer.

The above described program may be provided while being stored in a recording medium, or may be provided via a communication unit. In such a case, for example, the above described program may be regarded as the disclosure of a “computer readable recording medium having a program recorded therein.”

The “computer readable recording medium having a program recorded therein” refers to a computer readable recording medium having a program recorded therein, which is used for installing, executing, and distributing the program.

Examples of the recording medium may include a digital versatile disk (DVD), “DVD-R, DVD-RW, and DVD-RAM” which are standards formulated in a DVD forum, and e.g., “DVD+R and DVD+RW” which are standards formulated in DVD+RW, a compact disk (CD), e.g., a read-only memory (CD-ROM), a CD recordable (CD-R), and a CD rewritable (CD-RW), a Blu-ray (registered trademark) disc, a magneto-optical disk (MO), a flexible disk (FD), a magnetic tape, a hard disk, a read only memory (ROM), an electrically erasable programmable read only memory (EEPROM (registered trademark)), a flash memory, a random access memory (RAM), and a secure digital (SD) memory card.

Then, the whole or a part of the above program may be stored or distributed while being recorded in the above recording medium. The program may be transmitted through a communication using a transmission medium such as a wired network or a wireless communication network used in, for example, a local area network (LAN), a metropolitan area network (MAN), a wide area network (WAN), the Internet, an intranet, and an extranet, or a combination thereof. Also, the program may be carried on a carrier wave.

The above program may be a part or the whole of another program, or may be recorded in a recording medium together with a separate program. Also, the program may be dividedly recorded in plural recording media. The program may be recorded in any manner such as compression or encryption, as long as the program may be restorable.

The above described exemplary embodiments (mainly, the first exemplary embodiment) may be grasped as follows.

For example, the exemplary embodiment may address the followings.

When a deployment table is created by specifying an arbitrary item from a relationship diagram as an axis, all items in the relationship diagram are not reflected as axis items in the deployment table. Therefore, it is thought that an inconsistency may occur when the deployment table is corrected, and the correction contents are reflected in the relationship diagram. For example, in a case where an axis item is corrected in the deployment table, even when the same correction is made to the same item as the axis item, in the relationship diagram, it is not possible to determine the relationship between the item as a correction target and another item (in particular, an item not reflected in the deployment table). Thus, it is thought that am inconsistency may occur when a correction result of the deployment table is automatically reflected in the relationship diagram.

According to the exemplary embodiment of the disclosure, there is provided an information processing apparatus and a non-transitory computer readable medium, in which a relationship diagram is displayed in association with a deployment table as a correction target so that reflection of correction contents may be easily performed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a first setting unit that sets how events in a relationship diagram change;
a second setting unit that sets, with respect to two of the events connected by a relationship line, whether a change in one of the two events is related to a change in another of the two events or there is no specifiable relationship between the changes; and
a display unit that displays, according to the setting by the second setting unit, a relationship line in such a way that a relationship line indicating that a change in one event is related to a change in another event is distinguishable from a relationship line indicating that there is no specifiable relationship between a change in one event and a change in another event.

2. The information processing apparatus according to claim 1, wherein
the second setting unit further sets, with respect to two of the events connected by a relationship line, whether a tendency of occurrence of one of the two events is similar or opposite to a tendency of occurrence of another of the two events, and
the display unit further displays, according to the setting by the second setting unit, a relationship line in such a way that a relationship line indicating that a tendency of occurrence of one event is similar to a tendency of occurrence of another event is distinguishable from a relationship line indicating that a tendency of occurrence of one event is opposite to a tendency of occurrence of another event.

3. An information processing apparatus comprising:
a first setting unit that sets how events in a relationship diagram change;
a second setting unit that sets, with respect to two of the events connected by a relationship line, whether a tendency of occurrence of one of the two events is similar or opposite to a tendency of occurrence of another of the two events; and
a display unit that displays, according to the setting by the second setting unit, a relationship line in such a way that a relationship line indicating that a tendency of occurrence of one event is similar to a tendency of occurrence of another event is distinguishable from a relationship line indicating that a tendency of occurrence of one event is opposite to a tendency of occurrence of another event.

4. The information processing apparatus according to claim 3, wherein
the second setting unit further sets, with respect to two of the events connected by a relationship line, whether a change in one of the two events is related to a change in another of the two events or there is no specifiable relationship between the changes, and
the display unit further displays, according to the setting by the second setting unit, a relationship line in such a way that a relationship line indicating that a change in one event is related to a change in another event is distinguishable from a relationship line indicating that there is no specifiable relationship between a change in one event and a change in another event.

5. The information processing apparatus according to claim 1, further comprising a generating unit that generates a deployment table through converting the relationship diagram into the deployment table in such a way that a change in an event to be shown in the deployment table tends to increase.

6. The information processing apparatus according to claim 5, wherein
the generating unit corrects the relationship diagram in such a way that a causal relationship is maintained and a change in an event to be shown in the deployment table tends to increase, before converting the relationship diagram into the deployment table.

7. The information processing apparatus according to claim 1, further comprising a generating unit that generates the relationship diagram through converting a deployment table into the relationship diagram in accordance with a relationship between events in the relationship diagram.

8. The information processing apparatus according to claim 1, further comprising:
a storage unit that stores a first term for use in the relationship diagram and a second term for use in a deployment table in association with each other; and
a conversion unit that converts the first or second term into the second or first term by using the storage unit when the relationship diagram or the deployment table is converted into the deployment table or the relationship diagram.

9. The information processing apparatus according to claim 8, wherein
the storage unit allows setting of information indicating that the first and second terms are opposite in increase or decrease, and
the conversion unit converts the deployment table or the relationship diagram in such a way that an event occurrence tendency in the deployment table or the relationship diagram as a conversion destination is inversely related to an event occurrence tendency in the relationship diagram or the deployment table as a conversion source when information indicating that the first and second terms are opposite in increase or decrease is set in the storage unit.

10. A non-transitory computer readable medium storing a program causing a computer to execute information processing, the information processing comprising:
first setting including setting how events in a relationship diagram change;
second setting including setting, with respect to two of the events connected by a relationship line, whether a change in one of the two events is related to a change in another of the two events or there is no specifiable relationship between the changes; and
displaying, according to the second setting, a relationship line in such a way that a relationship line indicating that a change in one event is related to a change in another event is distinguishable from a relationship line indicating that there is no specifiable relationship between a change in one event and a change in another event.

11. A non-transitory computer readable medium storing a program causing a computer to execute information processing, the information processing comprising:
first setting including setting how events in a relationship diagram change;
second setting including setting, with respect to two of the events connected by a relationship line, whether a tendency of occurrence of one of the two events is similar or opposite to a tendency of occurrence of another of the two events; and
displaying, according to the second setting, a relationship line in such a way that a relationship line indicating that a tendency of occurrence of one event is similar to a tendency of occurrence of another event is distinguishable from a relationship line indicating that a tendency of occurrence of one event is opposite to a tendency of occurrence of another event.

12. An information processing apparatus comprising:
a display unit that indicates, on a relationship diagram or a deployment table, that the relationship diagram has a causal relationship not expressible in the deployment table, when there is such a causal relationship among causal relationships between events in the relationship diagram.

13. The information processing apparatus according to claim 12, further comprising a conversion unit that converts the relationship diagram into the deployment table, wherein
the display units indicates that there is a causal relationship not expressible in the deployment table, when such a causal relationship is found in the conversion of the relationship diagram into the deployment table by the conversion unit.

14. The information processing apparatus according to claim 13, wherein
the display unit performs any one of:
displaying a relationship line on the relationship diagram in such a way that a relationship line indicating the causal relationship not expressible in the deployment table is distinguishable from other relationship lines;
displaying events on the deployment table in such a way that events connected by the relationship line is distinguishable from other events; or
displaying both the relationship line and the events on the relationship diagram and the deployment table in such a way that the relationship line and the events are distinguishable from other relationship lines and events.

15. The information processing apparatus according to claim 12, wherein
the causal relationship not expressible in the deployment table includes a case where events on a single axis in the deployment table are connected by a relationship line or a case where events on non-adjacent axes in the deployment table are connected by a relationship line.

16. The information processing apparatus according to claim 12, wherein
when events in the relationship diagram correspond to axes in the deployment table and when the relationship diagram has a causal relationship occurring in a direction opposite to a cause-effect direction in the deployment table, the display unit indicates, on the relationship diagram or the deployment table, that there is the causal relationship in the direction opposite to the cause-effect direction in the deployment table.

17. The information processing apparatus according to claim 16, wherein
the display unit indicates, in a cell showing a combination of events in the deployment table, that there is the causal relationship in the opposite direction.
